(19) United States
(12) Patent Application Publication
(10) Pub. No.: US 2025/0284922 A1
(43) Pub. Date: Sep. 11, 2025

(54) PERSISTENT LEARNING FOR ARTIFICIAL INTELLIGENCE CHATBOTS

(71) Applicant: MicroStrategy Incorporated, Vienna, VA (US)

(72) Inventors: Jingbin Zhang, Hangzhou (CN); Jaime Alberto Perez, Brambleton, VA (US); Tingting Jin, Vienna, VA (US); Ellen Wang, Great Falls, VA (US); Deepak Karuppiah, Vienna, VA (US)

(21) Appl. No.: 19/191,684

(22) Filed: Apr. 28, 2025

Related U.S. Application Data
(63) Continuation-in-part of application No. 18/596,738, filed on Mar. 6, 2024.
(60) Provisional application No. 63/697,439, filed on Sep. 20, 2024.

(51) Int. Cl. G06N 3/006; G06N 3/0455

(52) U.S. Cl. CPC G06N 3/006; G06N 3/0455

(57) ABSTRACT

Methods, systems, and apparatus, including computer programs encoded on computer-storage media, for persistent learning for artificial intelligence chatbots. In some implementations, a system stores data indicating criteria for initiating learning in a chatbot system, where the criteria indicate conditions that trigger storage of a learned item to persist across sessions or conversations. The system receives a user prompt and generates a chatbot response. The system provides the chatbot response, and detects that the one or more criteria are satisfied, for example, based on a subsequent user prompt or other user feedback after the chatbot response is provided. In response to detecting that the one or more criteria are satisfied, the system adds a learned item to data storage, and the system is configured to use the learned item to generate chatbot responses in other sessions or conversations.

### CROSS-REFERENCE TO RELATED APPLICATIONS

This application is a continuation-in-part of U.S. patent application Ser. No. 18/596,738, filed on Mar. 6, 2024, and this application claims the benefit of priority to U.S. Provisional Patent Application No. 63/697,439, filed on Sep. 20, 2024, and the entire contents of the previous applications are hereby incorporated by reference herein.

### BACKGROUND

The present specification relates to techniques for enabling persistent learning for artificial intelligence chatbots.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system is configured to provide chatbot functionality using artificial intelligence or machine learning (AI/ML). The computer system can include features that improving quality and accuracy of chatbot responses through learning from user feedback. The computer system can analyze user feedback and allow chatbot behavior to adapt and improve, so that the chatbots provide more contextually-relevant and precise responses over time and also avoid repeating a previous mistake.

In many situations, learning is personal or specific to a particular user. For example, users may have different preferences for a response format or which criteria to use in making a decision. Similarly, different users may use the same phrase, acronym, or nickname to refer to different things. To accommodate the differences among users, in some implementations, the computer system can be configured to perform learning separately for each user, e.g., with a different set of learned information for each user. Learning on a per-user level allows the system to tailor chatbot responses to individual preferences by applying the learnings during subsequent conversations.

In some implementations, the computer system is configured to apply the learning for a user across multiple applications or chatbots. As a result, a correction or preference expressed by the user in a conversation in one chatbot interface or application can be applied to other chatbot interfaces or applications with the same user. This way, when users have access to multiple chatbots, the user does not need to separately instruct each chatbot with the same information or preferences. The system retains the information learned from interactions with one chatbot and can apply the learned information generally across a set of chatbots or across all chatbots when they interact with that user. In some implementations, the system provides users and administrators a learning manager interface with controls to view, edit, and delete past learnings, or to restrict the scope that specific learned items are applied (e.g., limit a preference or definition to specific chatbots or for interacting with specific topics or data sets).

The computer system can apply learning by storing records of learned information in persistent storage that persists across conversations and interaction sessions with the chatbots. For example, separate from the content of the chatbot conversation, and separate from the context that a large language model uses during the conversation, the computer system can store records of individual learned items in a database, where they persist after conversations and chatbot interaction sessions end. The learned items can be applied later to new conversations, including different conversations than the ones in which the learned items were initially learned by the system. Learned items can be stored in association with a user identifier for the corresponding user, so learned items can later be applied to the correct users.

The computer system can store individual learned items as discrete elements that can be added, modified, or deleted separately, which allows fine-grained control of learning for the system and for users. The system can be configured to save learned in specific categories or types of information. For example, one type of learned item can be an interpretation or a relationship (such as a mapping of a term or phrase to a data object in a data model), another type of learned item can be a criterion (such as whether the “best” movie should be determined according to movie critic rating, user rating, or box office sales), and another type of learned item can be a preference or threshold (such as “high performing employees” being those with a performance score of 4 or higher).

Beyond allowing careful management of storing learned information, this technique of learning discrete items also improves efficiency by allowing specific learned items to be retrieved and applied when they become relevant. This allows the system to efficiently use limited context sizes and processing power by focusing on specific items that are identified to be relevant, rather than causing an AI/ML model to sift through the set of learned information for the user for each response, when most or all of the learned information may not be relevant for the current response.

The computer system can be configured to save new learned items selectively, in response to detecting that predetermined criteria for persistent learning have been satisfied. For example, the computer system can store rules, policies, patterns, or other data that specifies the criteria to determine when new learned items should be created. The computer system can then monitor user interactions (including the content of chatbot conversations and user feedback about the conversations) to trigger learning when the predetermined criteria are satisfied. The criteria can include, for example, levels of confidence, types of information, sequences of events, and so on. For example, the computer system can be configured to learn a new piece of information when a level of confidence (e.g., a confidence score) satisfies a minimum threshold, but not before. As another example, the criteria may specify that learning occurs when users define particular types of information, such as the meaning of a term or phrase, a mapping of a data object to a term or phrase, specifying a rule or criterion for the chatbot to use (e.g., defining which metric to judge what is “best” or setting a threshold value for a decision), and so on. As another example, the criteria may specify that learning should occur when a sequence of events or chat interactions occurs, such as a user asking to correct or modify a previous answer (e.g., so the system learns to provide the answer in the corrected format the next time), or the system detecting an ambiguity and the user providing a selection to resolve the ambiguity. By setting criteria for triggering learning, the computer system can limit when persistent learning occurs, which increases accuracy by avoiding learning items that are likely to change or may be unimportant.

The computer system can also store learned items in association with a particular context, so that the application of the learned item is appropriately limited. For example, if the system learns a definition or interpretation for a nickname or acronym, the resulting learned item can be linked to the context in which the definition or interpretation was provided. If the definition was provided for a finance dataset, the learned item that is stored can be tagged or otherwise associated with the finance dataset or the finance topic. Then the computer system can later limit use of the learned item to generate output related to the finance topic or finance data set, rather than applying it in an unrestricted manner where it may not be applicable (e.g., for engineering data sets, for human resources conversations, etc.).

To improve the user experience, the computer system can provide a notification in the chatbot user interface when a new item is learned. For example, in response to detecting an instance in which the criteria for persistent learning have been satisfied, the computer system can cause a notification indicating what has been learned to be provided. This notification can be provided along with the chatbot response that makes use of the learned information, so the user can see the relationship and how the learned item influenced the response. In addition, in some implementations, the notification can include a control allowing the user to cancel or “forget” the learned item. If the user disagrees with the learned item, or does not want it to persist across chatbots, sessions, and conversations, the user can use the control to remove the learned item. This provides a mechanism for users to detect and remove an unwanted learned items, which helps maximize the accuracy and usefulness of chatbot responses.

The computer system can be configured to selectively apply learned items when the computer system detects that the learned items are relevant. For example, rather than automatically provide the collection of all learned items for a user for every chatbot conversation or chatbot response, the system can assess, for each user prompt, whether any learned items are relevant to the user prompt. As a result, the system can identify specific learned items that are relevant to specific prompts, and can provide different learned items to assist the AI/ML model in answering different prompts. Limiting the set of learned items provided improves accuracy by limiting the risk that AI/ML models may improperly apply irrelevant items. The technique also improves efficiency by reducing the amount of context that needs to be processed by the AI/ML model for each response. The computer system can be configured to use various types of data and context of a conversation to determine whether a stored learned item is relevant, including topics in the conversation, the data set(s) associated with the conversation or the chatbot, keywords in the most recent user prompt or earlier in the conversation, and so on.

The computer system can be configured to provide a notification to a user when a learned item is used to generate an answer. In many cases, a user may not on his or her own realize or remember that a learned item has been stored and is affecting a chatbot answer, especially if the information was learned using a different chatbot interface, a different device, a different conversation, etc. Some learned information may have been learned days, weeks, months, or years before the current use in response to a new user prompt. As a result, the computer system can notify the user that the learned item has been used, with a description of the information used (e.g., describing the relationship or preference that is applied). The computer system can also provide an interactive control for the user to edit or delete the learned item, which may be outdated or may not be applicable in the current context. For example, when a learned item is used by the chatbot to generate an answer, the computer system can cause the user device to provide a button to cause the system to “forget” the learned item. If the user selects the button, the system can remove the learned item from the set of persistent learned items for the user, and the system can generate and provide a replacement answer that is not based on the learned item that the user indicated should be forgotten.

In some implementations, the system is configured to detect ambiguous statements in a user's prompt. Many times, the user's input prompt to a chatbot is vague or ambiguous, so that there are potentially multiple interpretations or multiple types of valid answers. The system can use various techniques to detect and resolve ambiguity to improve the accuracy of chatbot responses. The system can also use the interactions with the user to learn pieces of information that are used in the current session or conversation, as well as stored and used in later sessions or conversations.

As an example, a user may ask a chatbot, “what are the 10 best movies?,” but it is unclear what criteria should be used to determine what “best” means in this context. Further, the appropriate meaning may vary from user to user. For example, one user may consider the best movies to be those with the highest audience ratings, another user may consider the best movies to be those with the best ratings from movie critics, another user may consider the best movies to be those that performed the best financially (e.g., highest total box office sales), and so on. An answer based on any of these interpretations is a valid answer to the question, but they may not provide the answer the user was seeking when the user submitted the prompt.

The system can instruct the AI/ML model to inform the system when ambiguity is present or additional information would be needed, even when this is provided together with a likely answer that the AI/ML model provides. When ambiguity is detected, the system can initiate a further interaction with the AI/ML model to identify possible interpretations for an ambiguous term or concept, even before the user provides further input. For example, before, during, or after presentation of an answer to a prompt detected to contain ambiguity, the system can initiate a round of interaction with the AI/ML model to request content such as (1) different potential meanings of the ambiguous term or concept, and (2) a response corresponding to each of the potential meanings or at least a few (e.g., 3, 5, etc.) of the most probable meanings of the ambiguous term or concept. Then, using the output of the AI/ML model for this round of communication, initiated by the system and not by any further prompt of the user, the system can supplement the initial answer provided to the user with additional information that answers the user's original prompt according to the different interpretations.

As an example, in the case of the prompt “what are the 10 best movies,” the system may coordinate with the AI/ML model to generate and provide a first chatbot response to the user, such as “According to this movie ranking web site, the top 10 movies are . . . ” The response from the AI/ML model may indicate to the system that ambiguity is detected, and potentially that the ambiguity is about the criteria for determining what is “best” in the context of movies. In response, the system can send a request to the AI/ML model, requesting that the AI/ML model identify the top three alternative interpretations for “best” in this context and providing an answer for each of the three alternative interpretations. The system initiates this further request based on the indication from the AI/ML model that ambiguity is present, and not in response to any further user prompt, since the user has not yet responded to the results. The AI/ML model then responds by providing the requested alternative answers, each based on a different interpretation of the ambiguous term “best.” The system can provide these three additional answers to the user in one or more supplemental responses to the user's original question. For example, “The top 10 movies by film critic rating are . . . ,” “The top 10 movies by audience rating are . . . ,” and “The top 10 movies by box office sales totals are . . . ” The system, by automatically providing these supplemental results, has provided information that is much more likely to satisfy the user's original intent when the prompt was made. In addition, these results are provided without requiring the user to make any further prompt or request. In addition, the user receives an initial response with very quickly, and can be reviewing that answer in parallel with generation of the alternative answers, which results in very high responsiveness and low perceived latency by the user.

The system can use the alternative answers (e.g., answers based on alternative criteria or alternative interpretations of an ambiguous term) as a way to build contextual knowledge. For example, the system can ask the user “did you mean . . . ” and provide the alternative answers, allowing the user to select whether one of the alternatives captures the meaning or criteria the user intended. The system can make the alternative answers interactive (e.g., selectable, as buttons or other controls). If the user selects one of the alternative answers, the system learns from the user's affirmative indication of the preferred answer. For example, the system can store a setting or record that indicates that, for the current context (e.g., the topic of movies), the “best” movies should be interpreted with the criteria used for the selected answer (e.g., criteria of “highest audience score” if the user selects the answer defined according to audience score). The system can store this learned item in a database, to persist and be used to generate chatbot responses when it is relevant, even after the session or conversation in which the item was learned has ended.

The computer system can support interactive applications where processing tasks for responding to a user prompt are split between non-AI/ML or non-probabilistic data processing systems (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model—and any third-party providing the AI/ML model as a service—access to portions of the dataset that are not appropriate for answering the current question.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

Through the course of interactions with chatbots, users often provide information that is part of the conversation and that is used as context for the chatbot to generate responses. Although user prompts inform the chatbot during a conversation or a session, the information does not always remain applicable to future sessions or conversations. Indeed, it is not desirable for all information to be carried over to later sessions and later conversations, because these will often address different topics and may be irrelevant and cause confusion, lowering the quality of answers. In addition, AI/ML models have limited context and also the larger amounts of context increase cost, power usage, and processing time. As a result, it has generally not been desirable to share user-provided information between sessions or conversations.

To implement learning that persists, the system can recognize situations when items obtained from the user (e.g., facts, interpretations, relationships, and preferences) should persist and be re-used across conversations and sessions. For example, the system can use predetermined rules or criteria that indicate patterns of user actions (e.g., events, sequences, etc.) or other scenarios indicative that learning can occur to trigger learning. One example that may trigger learning is where the user supplies a correction to a chatbot's answer, or makes a request for a specific interpretation. In other cases, the system may infer learned information though the pattern of responses or interactions, without the user providing explicit information or feedback. To maintain accuracy, the system can inform the user of the learning that is being stored, so the user can cancel or undo the learning if it is not appropriate.

Learning can provide a variety of advantages. The user can interact and provide feedback once, and the learned information can be propagated or shared among multiple chatbots or across multiple documents or dashboards. The learning functionality allows a chatbot to learn each user's preferences gradually and automatically. The experience can be personalized or customized in different ways for different users, even when the users use the same chatbot. The learning increases accuracy to interpret relative terms or unusual terms, to resolve ambiguous terms, to tailor a response for a user's role or interests, etc. The learning can make the user aware of the learned information, so the user can change or remove learning if it is not appropriate. In addition, learning can be selective, according to criteria or thresholds, to better ensure only high-quality information is learned and that low-quality or inappropriate information does not degrade the chatbot experience.

The computer system can provide persistent learning, with learned items that are stored and reused across sessions and conversations, and can also be shared across multiple chatbots. Information can be learned once and used multiple times in a variety of context. Learning can be personalized for individual users, with learned items stored per user and with learning personalized for the user. For example, the system can store separate learning for each of different users to capture preferences and expectations, without causing conflicts. Learning can be triggered selectively, based on predetermined criteria (e.g., circumstances, conditions, patterns, or triggers). Learning can occur during the chat conversation, often in real time or near real time, through interactions in the chat interface and without the need to designate or upload any external sources of knowledge.

To facilitate learning, the system can provide feedback controls for users to provide feedback about chatbot answers. The system can detect ambiguity or identify options to clarify. The system can learn specific types of items, and can store learning as discrete learned items that can be managed (e.g., added, removed, altered) individually. Each individual item can be stored and recalled separately, so they can be selected and applied individual or in combination when they are most appropriate. The system detects when learned information is available. For example, the system can perform a RAG retrieval step on the learning database, among the user's own learned items. The learned items can be applied at any or all steps of multi-step processing to generate chatbot responses. This can be particularly helpful for the mapping of terms and concepts to data objects in the data model or data schema, to increase accuracy. This makes it more likely that the correct set of data and correct criteria for filtering, ranking, aggregating, etc. are applied. When learning occurs, the user can be notified of the learning as it happens. The system acknowledges the item learned, and the system restates the item learned. The user can be provided controls to remove the learned information if it becomes outdated or incorrect. The user can be notified when the personalized learning is used in generating an answer.

In one general aspect, a method performed by one or more computers includes: storing, by the one or more computers, data indicating one or more criteria for initiating learning in a chatbot system, wherein the one or more criteria indicate conditions that trigger storage of a learned item to persist across sessions or conversations; receiving, by the one or more computers, a user prompt from a user device over a communication network; generating, by the one or more computers, a chatbot response to the prompt using output of an artificial intelligence or machine learning (AI/ML) model; providing, by the one or more computers, the chatbot response over the communication network as a response to the user prompt; detecting, by the one or more computers, that the one or more criteria are satisfied; and in response to detecting that the one or more criteria are satisfied, adding, by the one or more computers, a learned item to data storage, wherein the one or more computers are configured to use the learned item to generate chatbot responses in other sessions or conversations.

In some implementations, the method includes: after providing the chatbot response, receiving data indicating user feedback for the chatbot response that is provided through user interaction with one or more user feedback controls presented in association with the chatbot response. Detecting that the one or more criteria are satisfied is based on the user feedback.

In some implementations, the user feedback comprises positive feedback from the user in response to the chatbot response; the method includes identifying an interpretation, a relationship, or a user preference corresponding to the chatbot response or an earlier chatbot response in the conversation; and adding the learned item comprises adding the identified interpretation, relationship, or user preference to be used to generate chatbot responses for the user in other sessions or conversations.

In some implementations, the user feedback comprises negative feedback from the user in response to the chatbot response; the method includes identifying an interpretation, a relationship, or a user preference corresponding to the chatbot response or an earlier chatbot response in the conversation; and adding the learned item comprises adding an alternative interpretation, relationship, or user preference, which is different from the identified interpretation, relationship, or user preference, to be used to generate chatbot responses for the user in other sessions or conversations.

In some implementations, detecting that the one or more criteria are satisfied comprises determining that user input submitted after the user prompt resolves an ambiguity in the user prompt that is identified by the system.

In some implementations, the method includes: after receiving the user prompt, detecting an ambiguity corresponding to at least a portion of the user prompt; providing, for display by the user device, multiple different options for resolving the ambiguity; and receiving data indicating a user-selected option from among the multiple different options. The learned item is based on the user-selected option.

In some implementations, the learned item specifies at least one of a threshold, an interpretation of a term, or a user-selected criterion.

In some implementations, detecting that the one or more criteria are satisfied comprises, after providing the chatbot response to the user prompt, determining that a subsequent user prompt provides a correction to the chatbot response, requests a change to the chatbot response, or requests a different chatbot response to the user prompt.

In some implementations, detecting that the one or more criteria are satisfied comprises determining that a predetermined sequence of interactions has occurred with the chatbot.

In some implementations, detecting that the one or more criteria are satisfied comprises identifying, based on one or more user interactions, a piece of information of a predetermined set of types of information.

In some implementations, the method includes causing one or more user feedback controls to be presented in association with the chatbot response, wherein the one or more user feedback controls indicate at least one control to indicate approval or disapproval of a chatbot response. Adding the learned item to the data storage is based on user interaction with the one or more feedback controls.

In some implementations, the method includes providing, for display by the user device, a notification that (i) describes the learned item and (ii) indicates that the learned item has been saved.

In some implementations, adding the earned item to the data storage comprises associating the learned item with an identifier for a particular user, wherein the one or more computers are configured to use the learned item to generate chatbot responses in other sessions or conversations of the particular user.

In some implementations, adding the earned item to the data storage comprises storing context data indicating a context in which the learned item was identified, including metadata that specifies at least one of a data set, topic, or chatbot involved.

In some implementations, the one or more computers are configured to use the learned item selectively based on whether the one or more computers determine that the learned item is relevant to a user prompt submitted by the particular user.

In some implementations, the AI/ML model comprises a large language model.

In another general aspect, a method performed by one or more computers includes: storing, by the one or more computers, learned items selected based on interactions of one or more users with one or more chatbots, wherein the learned items are persistent to be used across multiple sessions or conversations; receiving, by the one or more computers, a user prompt that a user issues to a chatbot, wherein the user prompt is received over a communication network; identifying, by the one or more computers, a learned item from among the stored learned items that is relevant to the user prompt; generating, by the one or more computers, a response to the user prompt based on output of an artificial intelligence or machine learning (AI/ML) model, wherein the response is generated based on the user prompt and the identified learned item; and providing, by the one or more computers, the generated response over the communication network in response to the user prompt.

In some implementations, the chatbot is provided by a chatbot system that includes the one or more computers; the user prompt is part of a current conversation or session with the chatbot, and wherein the identified learned item is not part of the content or context of the current conversation or session with the chatbot; and the identified learned item comprises information that the chatbot system extracted based on user interactions of the user through a chatbot interface during a previous conversation or session with the chatbot or a different chatbot.

In some implementations, the user prompt is part of a current chatbot conversation or session; and the learned item comprises an item of information determined by the one or more computers based on user input during a different chatbot conversation or session, wherein the learned item is stored in persistent storage across multiple sessions or conversations based on a determination by the one or more computers that one or more predetermined criteria for persistent learning of the item of information were satisfied during the different chatbot conversation or session.

In some implementations, the one or more computers are configured to (i) store different sets of learned items for different users and (ii) generate chatbot responses to user prompts from the different users based on the respective sets of learned items, such that, for each of the users, user prompts from the user are answered based on the set of learned items corresponding to the user.

In some implementations, the chatbot system is configured to limit use of the learned items such that each set of learned items is used to generate responses for the corresponding user and is not used to generate responses for other users.

In some implementations, the one or more computers are configured share learned items for the user among multiple chatbots, such that a learned item learned for the user based on interactions of the user with one of the multiple chatbots is made available for each other chatbot of the multiple chatbots to use in generating responses from the user.

In some implementations, the one or more computers can enable a setting that allows administrators or users to specify whether learned information from one chatbot is transferred (e.g., shared, extended, or made available) for other chatbots to user in generating responses.

In some implementations, storing the learned items comprises storing the learned items as items in a database, wherein the learned items are associated with user identifiers indicating the respective users whose interactions caused each learned item to be saved; and identifying the learned item comprises searching the database to identify the learned item from among a set of learned items associated with the user identifier for the user.

In some implementations, identifying the learned item comprises: generating a score for the learned item that indicates a level of relevance of the learned item to the user prompt; and determining that the score for the learned item satisfies a threshold indicating at least a predetermined level of relevance.

In some implementations, the one or more computers score the learned items for the user and determine which, if any, satisfy the threshold.

In some implementations, storing the learned items comprises storing, in a vector database, embeddings representing the learned items; and identifying the learned item comprises searching the vector database to select the learned item based on a distance between one or more embeddings for the user prompt and the embedding in the vector database that represents the learned item.

In some implementations, the one or more computers evaluate relevance or perform a nearest neighbor search of learning embeddings of the user with respect to one or more vector embeddings determined based on the user prompt.

In some implementations, the one or more computers store a user identifier in association with each learned item; or the one or more computers store a separate collection of learned data set for each user.

In some implementations, the one or more computers are configured to selectively generate learned items to persist across sessions or conversations; and the one or more computers are configured to identify learned items to persist during chatbot conversations with users based on user input from users during the chatbot conversations.

In some implementations, the one or more computers store data that indicates predetermined criteria for triggering learning of items to persist across sessions or conversations; and the one or more computers selectively learn, including by (i) monitoring interactions during chatbot conversations and (ii) triggering learning that persists across sessions or conversations in response to detecting instances in which the predetermined criteria are satisfied.

In some implementations, the learned items include at least one of facts, relationships, interpretations of terms or phrases, or user preferences.

In some implementations, generating the response to the user prompt comprises providing the learned item as input to the AI/ML model or as part of a context for the AI/ML model.

In some implementations, the method includes performing a retrieval augmented generation (RAG) step to identify and retrieve a learned item relevant to the user prompt from a vector database.

In some implementations, generating the response to the user prompt comprises: sending a first request for the AI/ML model to generate code or data processing instructions for retrieving data from a data set to respond to the user prompt; obtaining results from the data set based on generated code or data processing instructions from the AI/ML model; and sending a second request for the AI/ML model to generate a response to the user prompt using the results from the data set. The learned item is provided to the AI/ML model and used by the AI/ML model to generate output in response to the first request and/or the second request.

In some implementations, generating the response to the user prompt comprises obtaining output from the AI/ML model in which the AI/ML model uses the learned item to perform a mapping of terms or concepts of the user prompt to data objects of a data set.

In some implementations, the method includes providing a data model or data schema for the data set to the model.

In some implementations, generating the response to the user prompt comprises obtaining output from the AI/ML model in which the learned item is used by the AI/ML model to: set criteria, in code or data processing instructions generated by the AI/ML model, for retrieving data from a data set; or set criteria for processing retrieved data from a data set in generating the response to the user prompt.

In some implementations, generating the response to the user prompt comprises setting a threshold, based on the learned item, that is used by the AI/ML model or is applied by the one or more computers in generating the chatbot response.

In some implementations, the AI/ML model comprises a large language model (LLM).

In some implementations, the method includes, based on the chatbot response being determined using the learned item that was learned from a previous session or conversation of the user, causing the chatbot response to be presented with an indicator that the chatbot response was generated based on a previously learned item.

In some implementations, the method includes causing the chatbot response to be presented with a statement or summary of the learned item, wherein the statement or summary accompanies or is included in the chatbot response.

In some implementations, the method includes causing a user interface control to be presented, wherein the user interface control is configured such that user interaction is operable to initiate removal of the learned item, such that learned item is no longer used to generate responses to user prompts from the user.

In some implementations, the method includes causing one or more user feedback controls to be presented in association with the chatbot response in a user interface, wherein the one or more computers are configured to selectively store a new learned item to persist across sessions or conversations in response to detecting that user feedback provided through the one or more user feedback controls satisfies one or more predetermined criteria for triggering persistent learning.

In some implementations, the method includes determining an identity for and/or authenticating the user; and selecting learned items from among a limited set of learned items for the user. For example, the one or more computers can be configured to limit its search for learned items to only items learned based on the interaction or feedback of the user.

In some implementations, the AI/ML model comprises a large language model (LLM).

In some implementations, the one or more computers provide learned information to the AI/ML model in association with a request for the AI/ML model to generating the code or instructions for database retrieval (e.g., SQL).

In some implementations, the method includes providing learned information to the AI/ML model in association with a request to process data retrieval results or to generate a response to a prompt based on data retrieval results.

In some implementations, the learned items were automatically added based on user feedback. For example, the learned items can be automatically added based on meeting predetermined criteria for entering information as learning in the learning dataset. The user feedback can include a rating from the user for an answer of a chatbot, a classification of a chatbot answer, a text response, or a subsequent user prompt after a chatbot response.

In some implementations, the method includes a search that includes vector search or similarity search over a set of learned items for the user, each of the learned items having met at least one of the rules or criteria for learning or having been added based on interactions of the user.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1A-1B are diagrams showing an example of a system that can learn during a conversation of an AI/ML chatbot and save the learned information in a persistent manner to be applied later.

FIGS. 2A-2C are user interfaces that provide examples of learning and using learned information in conversations with an AI/ML chatbot.

FIGS. 3A-3B are user interfaces showing an example of learning based on a user selection to resolve an ambiguity.

FIGS. 4A-4B are user interfaces that show learning during conversations with an AI/ML chatbot.

FIG. 5 is a user interface showing an example of learning during a conversation with an AI/ML chatbot.

Like reference numbers and designations in the various drawings indicate like elements.

### DETAILED DESCRIPTION

In some implementations, a computer system includes functionality to learn during conversations with users, and to store learned items in a persistent manner so they can be used later, even for different conversations, sessions, devices, interfaces, or chatbots. The system can automatically learn items based on the interactions of users, such as explicit or implicit feedback from users. This can include user interactions with feedback controls and/or from the content of user prompts submitted after a chatbot response is provided. The system can be configured to learn selectively, for particular types or categories of information and when the system detects predetermined criteria for triggering learning are satisfied. The system can also apply the learning automatically, for example, by selectively providing specific learned items to an AI/ML model when the system determines that the learned items are relevant to a user prompt.

In some implementations, the computer system classifies questions or prompts submitted by a user, and can change the content and characteristics of the response based on the classification. For example, the system can provide a prompt to an AI/ML model and ask the model to classify whether the prompt includes an ambiguous question. If an ambiguity is detected, the system can then be configured to perform a different processing workflow, or to use different instructions to an AI/ML model for generating a response, based on this classification.

One aspect of the technique is to provide users with smart alternative answers for their queries when ambiguity is detected. This ensures that, alongside a default answer, the chatbot presents alternative answers based on alternative interpretations. This can be provided in a supplemental answer that asks the user, “Did you mean?” and then shows one or more answers based on alternative interpretations. The alternative answers can be designed to clarify ambiguity, by using interpretations that cause the answer to diverge and become evident to the user. This enables a more tailored and accurate response to the user's original question.

As an example of an ambiguous query, a user may ask “Show me the top three best-performing employees.” The dataset has metrics such as “Revenue Generated”, “quarterly performance score”, “new customers acquired”, “YoY, Revenue growth”, and “customer satisfaction score,” but there is no criteria defined in advance for how to select the best employees. The system identifies the data objects available as possible measures to use for determining the interpretation for “best-performing” in the ambiguous user prompt. The system initially provides a default answer: “Top 3 employees by quarterly performance score are X, Y, and Z”. The system then also provides several alternative answers, as suggestions that may more closely align with the user's intent, “Did you mean: Top three employees by revenue generated are Top performers based on new customer acquisition in the last year are . . . . Best-performing employees in terms of customer satisfaction in 2023 are . . . ” When the user selects one of the three options, the system can automatically store a record that retains the user's preferred interpretation (e.g., whether to use revenue generated, new customer acquisition, or customer satisfaction as the metric for ranking employees). This information is learned automatically in response to the user's selection, and the system stores it persistently as a learned item that can then guide how the chatbot provides answers in future conversations and sessions with the user. In particular, the next time the user asks about the “best-performing” employee, the system will detect that the learned information is relevant, provide the learned item to the AI/ML model, and provide a response that uses the meaning of “best-performing” employee that was learned from the prior user interaction.

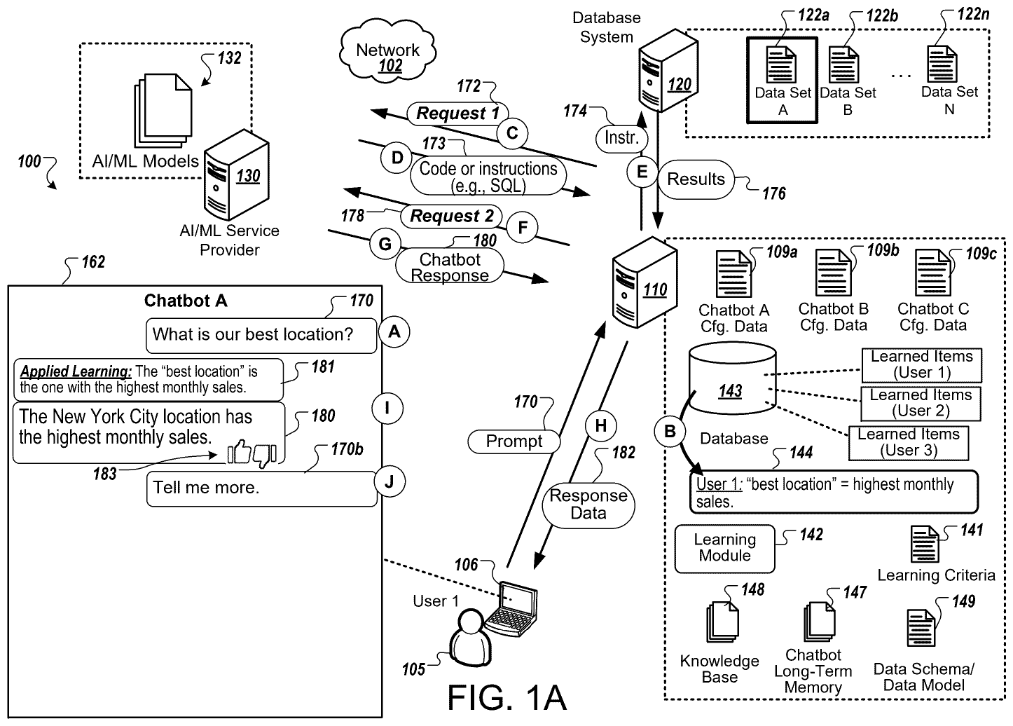

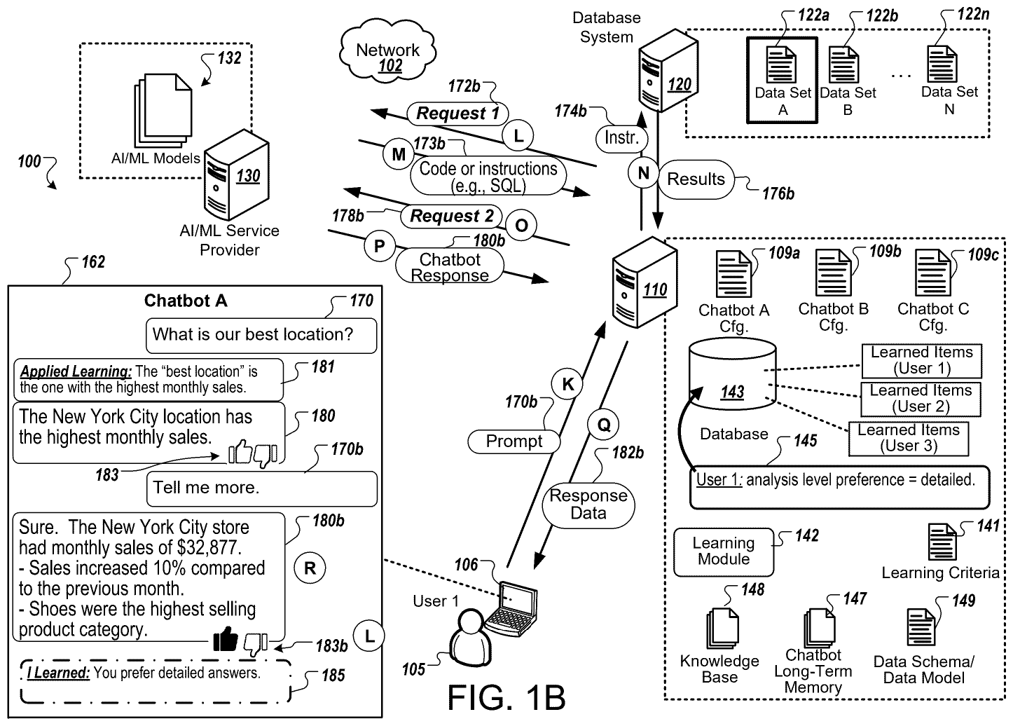

FIGS. 1A-1B are diagrams showing an example of a system 100 that can learn during a conversation of an AI/ML chatbot and save the learned information in a persistent manner to be applied later. FIG. 1A shows an example in which previously learned information is used by the system to provide a chatbot response. FIG. 1B shows an example where user interactions with the chatbot result a new learned item being saved.

The system 100 includes a computer system 110, a database system 120, and an AI/ML service provider 130. The system also includes a user device 106 of a user 105. The elements of the system 100 communicate over a network 102, such as the Internet. The computer system 110 coordinates a variety of operations to provide and manage access to chatbots and other AI/ML applications. In the example, the user 105 enters a user prompt 170 for a chatbot, and the computer system 110 coordinates the generation of the answer by the chatbot, including a text response 180 generated by an AI/ML model 132. The example of FIG. 1A includes stages (A) to (J), which represent various operations and a flow of data, and which can occur in the order illustrated or in a different order. FIG. 1B shows additional stages (K) to (L), which also represent various operations and a flow of data, and which can occur in the order illustrated or in a different order.

The computer system 110 can produce chatbot answers with high accuracy and high reliability using learned information determined from user feedback or sequences of user interaction. By detecting when users indicate a preference or specify an interpretation, and saving it for the user, the computer system 110 can automatically create and update a personalized set of information that customizes the behavior of the chatbot for the user. This allows the behavior of the chatbot to be customized in different ways as different items are learned for different users. The items that are learned can be stored in a persistent manner. Rather than simply being accumulated in the context or record of a particular conversation, the learned items can be stored separately and persisted after the end of the conversation or session in which they are learned, so the information can be applied later for different conversations and sessions, or even for different chatbots.

The learning functionality allows the computer system 110 to provide chatbots that automatically improve over time and become increasingly useful to users. The computer system 110 can store learned items separate from the AI/ML model and the context or conversation history of the chatbot. The separate storage of learned items allows chatbots to improve without the need for any further training of the AI/ML models, which allows improvement in chatbot performance with excellent power efficiency and minimal delay. As an example, in many cases learned information is identified and used in the natural flow of a conversation, e.g., in real time or near real time, as a user preference or a preferred interpretation is indicated. Users can be notified during the conversations of new learned items as the learning occurs. In addition, an item learned once for a user can be used across different models and model updates, and even different model providers. This allows consistency in user experience across different models. If an updated version of a model is released, or a different AI/ML service provider is used, the computer system 110 can switch to use the new model and still retain all the customized learned information for users.

The computer system 110 can monitor and analyze interactions that occur during a chatbot conversation to automatically detect when a learnable item (e.g., a definition, a relationship, an interpretation of a term or phrase, a user preference, etc.) has been revealed and should be saved. For example, the computer system 110 can store a set of learning criteria 141 that specify rules or policies that define the conditions in which a new learned item should be saved to persist for future use. The conditions can include parameters such as particular types of information that can be learned (e.g., specific categories of information, such as definitions, criteria for ranking or filtering, mapping of terms to data objects, etc.), circumstances in which learning occurs, sequences of events that trigger learning, and a minimum level of confidence at which learning occur.

The computer system 110 can be implemented using one or more servers, such as one or more cloud computing systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. The computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

Chatbots can be provided by the computer system 110 or other systems, including third-party systems. Some or all of the chatbots may be executed or managed by the same server system or same operator as the computer system 110. Each chatbot can have an associated dataset 122a-122n (or multiple datasets) from which the chatbot derives information with which to generate responses to users. Each chatbot can also have a corresponding AI/ML model 132 designated to use for generating responses from the chatbot, such as a LLM. Each chatbot can also have a corresponding set of settings and customizations that specify various properties of the chatbot (e.g., text output tone and style, output format, verbosity, etc.). In the example, there are three chatbots, Chatbot A, Chatbot B, and Chatbot C, all of which are provided by the computer system 110. The computer system 110 stores a separate set of configuration data 109a-109c for each chatbot. Different chatbots may use different datasets 122a-122n or share the same datasets 122a-122n, and similarly different chatbots may use different AI/ML models 132 or share the same AI/ML model 132. Each chatbot can also include functionality to store conversation histories for each user across different sessions of use. In other words, for the user 105, each chatbot can store a separate, persistent chat history for the interactions of the user 105.

Different users have access to different datasets 122a-122n and different chatbots, depending on their roles, permissions, etc. In addition, two different users accessing the same chatbot may still have different customized experiences based on the users' differences in user preferences and settings. In addition, as discussed further below, each user can have a separate set of learned items that the computer system 110 as accumulated and saved over the course of the respective users' interactions with the chatbots. The user 105 authenticates to the computer system 110, so that the identity of the user 105 is determined and the user's permissions can be determined.

In the example of FIG. 1A, in stage (A), the user 105 enters a prompt 170 in a chat user interface 162, and the client device 106 of the user 105 sends the user prompt 170 to the computer system 110 over the network 102. The user 105 interacts with the chat interface 162 to enter the user prompt 170, which in this example is the question, “What is our best location?” In this example, the user 105 accesses a chat user interface 162 for interacting with AI/ML chatbots using a user device 106 (e.g., a phone, a laptop computer, a desktop computer, etc.). For example, the chat interface 162 can be part of a web page, a web application, a native application on the user device 106. The chat interface 162 can be displayed based on user interface data provided by the computer system 110 or another server.

In stage (B), the computer system 110 uses a database 143 of learned items to determine whether any learned items for the user 105 are relevant to the user prompt 170. In the example, the computer system 110 searches the database 143 and determines that, from among the learned items corresponding to the user 105, a learned item 144 is relevant to the user prompt 170. The computer system 110 retrieves this learned item 144, which indicates that the term “best location” means “highest monthly sales” (e.g., in the context of location, determining what is “best” should be done according to highest monthly sales). In this case, the “highest monthly sales” may be expressed as text describing the concept, or as an equation, or as an identifier for a specific data object in a data set 122a-122n (e.g., a “monthly sales” metric of a data table, which should be ranked in descending order).

The computer system 110 can be configured to store learned items as separate or discrete pieces of information that can be used separately when the context indicates relevance. Rather than automatically provide all learned information to an AI/ML model 132 each time, which would increase the amount of information that would need to be processed for each interaction, the computer system 110 can selectively provide one or more learned items that the computer system 110 selects as the most relevant for the current prompt 170 to be answered or task to be performed. In the example, the database 143 stores learned items that have been detected and stored as a result of previous user interactions with chatbots.

The database 143 can store records of learned items for each of various users. For example, the database 143 stores a set of learned items for the user 105 (e.g., User 1), and also stores sets of learned items for other users, e.g., User 2 and User 3. The learned items can be stored with metadata or other information that specifies the user that each learned item corresponds to. The database 143 can also store other information for each learned item, such as context information indicating one or more topics, keywords, or data sets relevant to the learned item, as well as information about the circumstances in which the item was learned (e.g., a chatbot, data set 122a-122n, a question type, a time and date, etc. corresponding to the conversation when the item was learned).

In some implementations, the database 143 is a vector database that uses a vector representation of the learned items in a high-dimensional vector space to characterize or represent the topics, keywords, or concepts involved in each learned item. To search the vector database, the computer system 110 can determine query vector representations of the topics, keywords, or concepts in the prompt 170 and/or other context of the conversation. The computer system 110 then compares the query vector representations with the stored vector representations of learned information for the user 105. Generally, the stored items that have vector representations closest to the query vector representations are most similar to or most relevant to the prompt 170. The computer system 110 can determine relevance scores based on distance or similarity metrics between the stored vector representations and the query vector representations. The computer system 110 can apply a ranking or other criteria to the scores, such as by filtering based on a threshold that must be met for a minimum level of similarity or a maximum distance in the vector space. If the computer system 110 finds that there is a highly relevant learned item stored, from among the set of items learned for the user 105, then the computer system 110 retrieves the corresponding information for use in generating the chatbot response.

In some implementations, the computer system 110 uses text comparisons or other search techniques to identify stored learned items in the database 143 that may be relevant to the user prompt 170. For example, the computer system 110 can determine that the phrase “best location” from the user prompt 170 is included in a particular learned item 144 (e.g., an item stating that, for User 1, “best location” means “highest monthly sales”), and so that item 144 is relevant to the user prompt 170. In other cases, the computer system 110 may generate relevance scores or similarity scores and identify the top-scoring learned item(s), and select those if they meet minimum thresholds for relevance. In general, the computer system 110 can maintain requirements for minimum levels of relevance so that learned items are only extracted and provided to the AI/ML models when there is high relevance or high confidence that the learned item will be useful, to avoid providing low-relevance information that may distract from or decrease the quality of chatbot output.

For many user prompts, there may not be any learned item that satisfies the minimum level of relevance needed to extract and use a learned item. For example, in many cases, learned items may be relatively sparce across the full range of topics a user may ask about, especially for new users. Even so, the computer system 110 is ready to provide a highly relevant learned item when one is available in the database 143. In some implementations, the computer system 110 scores learned items based on the similarity in the context in which the item was learned and the context of the user prompt 170. For example, some learned items may be more relevant to one topic, chatbot, or data set 122a-122n than another, and so the relevance can be weighted according to the similarity of the context. In some cases, learned items can be filtered or limited to be used only in certain contexts (e.g., learned items relating to attributes, metrics, or other data objects in a finance data set may be used only when a chatbot, data set, or context indicates that finance is relevant).

In stage (C), the computer system 110 generates and sends a first request 172 to the AI/ML service provider 130 based on the user prompt 170. The first request 172 can be a request for data retrieval code or instructions, e.g., a request for an LLM to generate a SQL statement or other criteria for retrieving and/or generating data from a data set. The first request 172 can include some or all of the user prompt 170. The first request 172 can also include information about the types of data available in the data set 122a, such as a data model 149 or data schema for the data set 122a.

In addition, where the computer system 110 has identified one or more learned items as relevant, the computer system 110 provides those identified items. These learned items enable the AI/ML model to better interpret the user prompt 170 and generate a response as the user intends. This can include, for example, using an interpretation (e.g., a meaning of a term, or a mapping of a term to a data object) that the user expects, resolving an ambiguity in the manner that the user has previously specified, using criteria for ranking or filtering that the user has specified, using a stored user preference of the user, or using a value of a threshold based on a user preference. In addition, the learned items can specify elements of style, content, formatting, and so on that the output should take.

In the example, the first request 172 provides the information in the learned item 144, which specifies that the term “best location” in the user prompt 170 should be judged according to highest monthly sales. There are many different criteria that could potentially be used to determine which location is best, since best is a term that is often subjective or context-dependent. For example, the “best” location might be considered to be the newest, largest, highest-rated by customers, highest sales, etc. The data model 149 for the data set 122a used by the chatbot may also indicate data objects for many different characteristics that would allow ranking or selection (e.g., age, size, customer rating, monthly sales, etc.). By providing the learned item 144 to the AI/ML model 132, the computer system 110 can guide the AI/ML model 132 to the interpretation that the user 105 prefers, which is that locations should be assessed according to monthly sales. Although the user may have needed to specify at one time that this is the preferred metric for ranking, the computer system 110 has automatically learned and stored this information, so it is automatically used in the future, such as for responding to the user prompt 170.

The first request 172 can be a request for an AI/ML model 132, such as an LLM, to generate code or instructions for a system (such as the database system 120) to use in retrieving and/or generating data to answer the prompt 170. For example, rather than asking the AI/ML model 132 to generate the answer to the prompt 170, the first request 172 can request a SQL statement, programming code, a list of operations, or other instructions that specify criteria that would retrieve and/or calculate the values needed to answer to the prompt 170. As a simple example, the prompt to the LLM in the first request 172 may include an instruction such as “provide a SQL statement that retrieves the data needed to answer the question <<user prompt>>,” or “generate Python code that can run on<<database system>> to calculate the answer to the question <<user prompt>>,” where the fields noted by “<< >>” are replaced with the content indicated or identifiers or references for the items indicated.

By requesting code or instructions, the process takes advantage of the ability of AI/ML models 132 to reliably produce high-quality code or instructions expressed in programming languages (e.g., SQL, Python, Java, HTML, XML, etc.). This often generates in a more concise and unambiguous result than more free-form text outputs. This type of request guides or constrains the AI/ML model 132 to follow the conventions of a particular programming language (which can be specified in the request 172). Programming languages are usually designed to avoid ambiguity and to promote consistency in usage of terms across many different situations. As a result, code examples often demonstrate clear usage patterns that the AI/ML models 132 can learn from and follow.

Also, by requesting that the AI/ML model 132 create the code or instructions using a standardized format, such as SQL, this greatly increases the number of different AI/ML models 132 that can be used with the system. For examples, many different LLMs may have a capability to create SQL, while models, if any, may be able to reliably generate visualizations or descriptions of visualizations. With many different options for selecting an AI/ML model 132 to create SQL, the computer system 110 has the versatility to vary which AI/ML service provider or model is used (e.g., for cost, speed, load balancing, etc.) and the robustness to change which model is used if a AI/ML service provider or model becomes unavailable.

Requesting that the AI/ML model 132 create code or instructions for data retrieval takes advantage of strengths of LLMs, such as natural language interpretation of the user's prompt 170 and ability to generate text, such as code, that follows established patterns or rules. This also constrains the constrains the form of the output to a set of code or instructions, such as SQL or another standardized representation, which allows the high-quality results to be achieved reliably.

To enable the AI/ML model 132 to reference the appropriate logical data objects of the relevant data set 122a (“Data Set A”), the first request 172 includes the data model 149 for the data set 122a to be used. The data model 149 can include information about the data set(s) that the chatbot will use to respond to the request 172, usually without providing any of the actual content of the data set. For example, the data model 149 can include a data schema for the data set 122a. In general, the data model 149 can indicate a list of logical objects represented in the data set 122a, such as a list of the elements or components of the data set, such as metrics, attributes, facts, and so on. For example, the data model 149 can indicate that the data set 122a includes logical objects such as date, customer identifier, region code, sales amount, and so on. These data objects can represent quantities or data objects that are represented in, or can be derived from, data in the data set 122a. The logical objects, such as metrics or attributes, can represent the type of data that is stored in or derived from a column of data. For example, an attribute may represent a type of data stored in a column of a data table or the result that would be obtained by applying a particular arithmetic expression to data in a column. Similarly, a metric or fact can represent the result of applying a particular aggregation function or other operation(s) to values in one or more columns of a data table. Accordingly, the data model 149 can indicate the attributes and metrics that are available for the AI/ML model 132 to work with, and potentially additional attributes or metrics that can be generated or operations that are available for the database system 120 to create a new attributes or metrics.

In some cases, the data model 149 can indicate, through the logical objects identified, data from tables, columns, and other elements that make up the data set 122a, in addition to or instead of the semantic meanings and/or relationships among these elements of the data set 122a. For example, the data model 149 can indicate that the data set 122a includes set of data named “sales_table,” that includes a metric named “sales_amount” that indicates amounts of sales and another attribute named “region” that indicates the region in which the sale occurred. These quantities may or may not correspond directly to the structure of the data set 122a. For example, the item “sales_table” may be an actual data table of a database, or may not represent a table and instead another grouping of data. Similarly, the “sales_amount” and “region” objects may correspond to specific columns of a data table, but may alternatively represent values that can be calculated or otherwise derived from the data set 122a in another way. Providing the data model 149 can give the AI/ML model 132 a list and description of the logical objects that the database system 120 recognizes, so that code or instructions generated by the AI/ML model 132 can use the identifiers known to the database system 120 and/or the computer system 110. As a result, the AI/ML model 132 can generate code or instructions that reference these logical objects that are understood by the computer system 110 and the database system 120. To the extent that the objects indicated in the data model 149 differ from the actual structure of the data set 122a, the computer system 110 and the database system 120 can use convert from the logical object names used in the data model 149 to actual data set elements and functions.

The data model 149 can indicate the names or labels for these data elements, classifications of the elements (e.g., metric, attribute, etc.), and other information. In some implementations, the data model 149 can include sample data for the data set 122a, such as a sampling of data from the data set 122a. The sample data can be fictitious example data that may be artificially synthesized to be representative of the data in the data set 122a (e.g., similar types of data), without indicating actual contents of the data set 122a. The data model 149 can be provided in any of various forms, such as a database schema from a database management system, a list or definitions of objects, components, or identifiers of the data set 122a, etc.

By providing the data model 149 with the request 172, the computer system 110 provides the AI/ML model 132 the ability to make use of the logical objects specified in the data model 149. As a result, the AI/ML model 132 can determine the types of data that would be available from the data set 122a, even without the AI/ML model 132 having any access to the data set 122a. The AI/ML model 132 can generate code or instructions (e.g., a SQL statement) that references these logical objects, with a clear set of names or other identifiers to accurately and unambiguously reference components of the data set 122a. For example, providing the data model 149 for the data set 122a, may enable the AI/ML model 132 to reference logical objects in generated SQL statements that the computer system 110 and/or database system 120 can unambiguously map the logical objects to tables and columns of the data set 122a. This allows the AI/ML model 132 to distinctly and unambiguously define criteria to specify the subset or portion of data to be retrieved from, or calculated based on, the data set 122a.

In some implementations, the first request 172 includes additional information that assist the AI/ML model 132 to interpret and respond to the user prompt 170 and other information, such as a knowledge base 148. The knowledge base 148 can provide a mapping for the AI/ML model 132 to map words and phrases with non-standard or idiosyncratic meanings (e.g., jargon, nicknames, etc.) to definitions, descriptions, or other indications of their meaning. The knowledge base 148 can include information determined at any of multiple levels, such as at the level of an enterprise as a whole, for a department or group of individuals, or for a specific individual. Similarly, the knowledge base 148 can be one that has been created for a single chatbot or AI/ML application or one that is shared with multiple chatbots or AI/ML applications.

In some implementations, the computer system 110 enables the administrator 103 to attach one or more additional data sets to adjust the operation and output of the chatbot. For example, an additional data set can be a knowledge base 148 or data dictionary can be added. Unlike the primary data set that the user selects for the chatbot (e.g., data set 122a), the chatbot is not configured to answer questions about the additional data set or to retrieve metrics or to provide visualizations of the knowledge base 148. Instead, the knowledge base 148 can be provided to assist the chatbot in interpreting user queries and providing responses with the terminology for the user's organization. In general, the knowledge base 148 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 148 is designated for the chatbot to describe these and other internal terms. Each time the user submits a prompt, the knowledge base 148 can be provided to assist the LLM with the context that is appropriate for the company. The knowledge base 148 can provide information similar to a semantic graph, by describing entities and their relationships. In some cases, the information in the knowledge base 148 can be derived from a semantic graph 150 and then converted into text (e.g., unstructured, semi-structured, or structured) in a format that can be processed by the LLM.

In general, the knowledge base 148 or other additional data set can include data that maps terms or phrases to their meanings. In many cases, this can include semi-structured data or explanatory content, as a way to explain entities and relationships wo the AI/ML models 132. Although the knowledge base 148 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 148 as contextual data sets that can be applied consistently across the enterprise, for all chatbots created and used in the enterprise. Similarly, different departments within the enterprise may add their own particular contextual data sets that may supplement the enterprise-wide knowledge bases 148. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 147 can additionally or alternatively be specified with a scope that corresponds to a computing environment, so that chatbots associated with a particular domain or server inherit the knowledge bases for that domain or server.

One of the advantages of the knowledge base 148 is consistency for many users and even for many different chatbots of an organization. The user submitting a prompt does not need to take any action to select or include the knowledge base 148 in the chatbot's processing, the chatbot automatically include the knowledge base 148 in its context for each prompt or question received. Also, because the knowledge base 148 can be shared or inherited by many chatbots within an organization, updating and maintaining the knowledge base 148 is simple. An edit to the knowledge base 148 is automatically applied to all of the chatbots associated with the organization, even if the chatbots were created by different administrators or provided to different sets of users.

In addition, the knowledge base 148 provides persistent context that is not lost from one prompt to another or from one session to another. The knowledge base content can also be implemented applied in a manner that the knowledge base 148 does not count toward the instruction token limits that the AI/ML models 132 consume for each response. Rather than counting toward the tokens for prompts and recent history, the knowledge base 148 can be accessed or provided to the AI/ML models 132 as a separate source of knowledge apart from the prompt and context, and so does not count toward the token limits of an LLM. Implementations of access to the knowledge base 148 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 148 can be prepared as an embedding, a vector database, or other format that can be accessed by or referred to by the AI/ML models 132.

The first request 172 can include additional information such as a conversation history for the user 105 and the chatbot, and/or a long-term memory 147 with information that persists across chat sessions. The history or memory 147 can represent any of various types of information that can be stored external to the AI/ML models 132 but captures information about previous sessions, previous conversations or previous text of the current conversation, preferences of one or more users, learning from feedback of one or more users, and so on. In some implementations, the chatbot is designed to have a long-term memory 147, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 147 for the chatbot. For example, the long-term memory 147 can store items such as definitions of terms for a particular user context, unique text elements the chatbot might encounter, and feedback from prior user interactions.

One valuable aspect of the long-term memory 147 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

In stage (D), the AI/ML service provider 130 uses one or more of the AI/ML models 132 to generate a response to the first request 172. The AI/ML service provider 130 then sends the response, e.g., code or instructions 173 (such as a SQL statement), to the computer system 110. As discussed above, the first request 172 requests code or instructions specifying the criteria or data processing operations that can be used to retrieve and/or generate (e.g., calculate) from the data set 122a the result data that would be needed to answer the user prompt 170.

In response to the request 172, the AI/ML service provider 130 uses the AI/ML models 132 to generate the code or instructions 173 that specify the criteria to retrieve and/or generate the data needed to answer the prompt 170. This part of the process leverages the ability of the AI/ML models 132, e.g., LLMs, to generate a set or sequence of instructions or operations. The data processing instructions 174 can be expressed in any of a variety of ways, such as one or more SQL statements, as executable or interpretable code, such as Python code, as a list of API calls or commands to be executed, and so on. The code or instructions 173 can provide instructions for retrieving specific portions of one or more data sets, such as from the specific data set 122a specified in the prompt 170 or otherwise indicated to the AI/ML model 132 used. The code or instructions 173 can additionally or alternatively instruct various data processing steps or operations to be performed, including data joins, data aggregations, filtering data, evaluating expressions, creating new metrics and calculating their values, etc.

The computer system 110 uses the code or instructions 173 generated by the AI/ML model 132 to generate data processing instructions 174 to be processed by the database system 120. For example, the computer system 110 can analyze and update the code or instructions 173, such to modify the SQL statement from the AI/ML model 132 to an enhanced or improved SQL statement. As a result, the data processing instructions 174 can be a combination of code or instructions 173 from an AI/ML model 132 and changes or enhancements added by the computer system 110.

In stage (E), the computer system 110 uses the data processing instructions 174 to instruct the database system 120 to obtain (e.g., retrieve, calculate, generate, etc.) the data needed to answer the user prompt 170. For example, the computer system 110 may send a request that includes the data processing instructions 174 to the database system 120, in order to request the needed data. In response, the database system 120 generates and sends results 176 that include the data retrieved from and/or generated based on applying the data processing instructions 174 for the dataset 122a. The database system 120 processes or executes the data processing instructions 174 that it receives, which creates the results 176, which may be in any of various forms, such as records retrieved, data series, aggregations of data, statistics about data in the dataset 122a, subsets of the dataset 122a determined to be relevant, and so on.

In stage (F), the computer system 110 sends a second request 178 to the AI/ML service provider 130. The second request 178 includes the results 176 and requests that the AI/ML models 132 generate a response that answers the prompt 170 based on the results 176. For example, the second request 178 may be a request to answer the prompt 170 using the data in the results 176 as context or as source material to generate the response. As another example, the second request 178 may be a request for the AI/ML models 132 to summarize the results 176, in addition to or instead of answering the user prompt 170. This second request 178 can include instructions to the AI/ML model that are selected based on learned item(s) determined to be relevant.

In many cases, the information provided with the first request 172 is retained in the current context of the AI/ML model 132, so the learned item 144, the data model 149, knowledge base information 148, long-term memory items 147, and other information is still available to the AI/ML model 132. In some cases, the learned item 144 that was selected, or the other information provided to the AI/ML model 132 with the first request 172 can be provided again with the second request 178.

In stage (G), the AI/ML service provider 130 uses the AI/ML models 132 to generate a response to the user prompt 170, e.g., a chatbot response 180 that includes natural language text providing the answer to the prompt 170 as determined from the results 176, using the interpretation specified by the learned item 144 that was identified from the database 143. For example, the second request 178 may include or provide access to the results 176 and the user prompt 170, and so the AI/ML models 132 generate a text response 180 to the prompt 170 from the values in the results 176. For example, in the illustrated example, the chatbot response 180 is text that one or more AI/ML models 132 generated that indicates that the New York City location has the highest monthly sales

In stage (H), the computer system 110 generates response data 182 and provides the response data 182 over the network 102 to the user device 106 as the response of the chatbot to the user prompt 170. For example, the response data 182 can include the text of the chatbot response 180. In this case, the response data 182 includes an answer based on the interpretation specified in the learned item 144, e.g., “The New York City location has the highest monthly sales,” which uses the interpretation of “best location” to be the one that has the highest monthly sales.

The computer system 110 also provides information describing the learned item 144. This can include data that instructs or causes the user device 106 to display a notification that a learned item was used to generate the chatbot response 180. Because the learned items in the database 143 are persistent, the learned item 144 may have been stored in response to a user interaction that occurred long ago (e.g., days, weeks, months, or even longer). In addition, the learned item 144 may have been learned from interactions with a different chatbot, or regarding a different data set 122a-122n, or in a different conversation or session of interaction.

In stage (I), the user device 106 receives the response data 182 and displays the response data 182 in the user interface 162. For example, the user device 106 presents the chatbot response 180. Because the computer system 110 identified and applied the learned item 144, the chatbot provided the information that the user 105 desired, instead of potentially applying a different interpretation of the phrase “best location” that the user 105 did not intend. In the example, to facilitate additional learning, the chatbot response 180 can be presented with user feedback controls 183. For example, the user can click a “thumbs up” icon to approve the response or click a “thumbs down” icon to indicate disapproval. The computer system 110 can receive and store feedback expressed through the user feedback controls 183, and these user interactions can trigger additional learning when the conditions of the learning criteria 141 are satisfied, as discussed further with respect to FIG. 1B.

The user device 106 also presents the notification 181 that indicates that a previously-learned item has been applied and also indicates the content of the learned item 144 (e.g., “The ‘best’ location is the one with the highest monthly sales”). Providing the notification 181 gives the user 105 a way to quickly see the learned item 144 that affected the content or form of the chatbot response 180. The notification 181 is also associated with (e.g., linked to or adjacent to) the related chatbot response 180, so it is clear that the response 180 is the message that was influenced by the learned item 144.

The computer system 110 can cause the notification 181 to include one or more associated controls to change how the learned item 144 is applied. For example, a control may be configured to remove application of the learned item 144, so that if the user 105 decides that learning is not applicable, the chatbot provides a replacement answer without that interpretation. As another example, a control can be provided to cause the computer system to delete or “forget” the learned item 144, so it will be removed from the database 143 and not applied in any future conversations. Other controls may enable the user 105 to change the context settings in which the learned item is applied. For example, the controls may be used to broaden or narrow the scope of circumstances or contexts that the computer system 110 uses the learned item 144. For example, the appropriate context can be defined in terms of topics, terms, data sets 122a-122n, chatbots, or other context characteristics.

In stage (J), the user 105 continues the conversation with the chatbot by entering and submitting the user prompt 170b, “Tell me more.” The example continues in FIG. 1B.

Referring to FIG. 1B, in stage (K), the user device 106 sends the user prompt 170b to the computer system 110 over the network 102. The computer system 110 then begins to process the user prompt 170b using the same functionality described with respect to FIG. 1A. In this case, the computer system 110 searches the database 143, but does not find any additional learned items from the database 143 that are relevant to the most recent user prompt 170b.

In stage (L), the computer system 110 sends a request 172b for the AI/ML service provider 130 to use an AI/ML model 132 to generate code or instructions for answering the user prompt 170b. In this case, the user prompt 170b does not indicate specific types of data that are desired, but the computer system 110 can nonetheless send a request for the AI/ML model 132 to provide code or instructions for results that the model 132 determines to be appropriate to answer the user prompt 170b, e.g., to provide “more” information about the “best location” initially referred to in the first user prompt 170, and which the previous interactions determined to be the New York City location. Although the computer system 110 and the AI/ML model 132 have available the original set of results 176, the focus of those interactions was on identifying the best location, and so additional information may be needed or may be useful in answering the next prompt 170b.

In stage (M), the computer system 110 receives code or instructions 173b that the AI/ML model 132 generated, using the techniques discussed above. In this example, the AI/ML model 132 interprets the request for more information to include more information about the New York City location and the monthly sales at that location, such as the amount of monthly sales, a change in sales over time, and the categories of products sold. Based on the data model 149, the AI/ML model 132 can refer to the specific data objects (e.g., metrics, attributes, etc.) in the data set 122a that will provide this information.

In stage (N), the computer system 110 uses the code or instructions 173b to provide data processing instructions 174b to the database system 120. The database system 120 provides results 176b that include the types of information specified, e.g., information for the data objects identified in the data processing instructions 174b.

In stage (O), the computer system 110 sends a second request 178b that provides the results 176b and requests a response to the user prompt 170b.

In stage (P), the computer system 110 receives a chatbot response 180b to the user prompt 170b that was generated by the AI/ML model 132.

In stage (Q), the computer system 110 generates response data 182b that includes the chatbot response 180b, and the computer system 110 provides the response data 182b to the user device 106 over the network 102.

In stage (R), the user device 106 displays the chatbot response 180b. As requested by the user 105, the response 180b provides more information about the New York City location and the monthly sales for the location: “Sure. The New York City store had monthly sales of $32,877.—Sales increased 10% compared to the previous month.—Shoes were the highest selling product category.” In the example, the chatbot response 180b is provided along with user feedback controls 183b.

In stage (L), the user 105 interacts with the user feedback controls 183b, in this case, to indicate approval of the response 180b. This feedback is provided to the computer system 110 over the network 102.

The computer system 110 is configured to monitor messages in chatbot conversations, as well as other user interactions, to determine when the learning criteria 141 are satisfied. The learning criteria specify the conditions for storing new learned items, and those conditions can be based on explicit feedback, implicit feedback, or a combination. The computer system 110 can include a learning module 142 that monitors interactions during chatbot conversations or sessions to detect when learning should be triggered and to extract learned items to be stored. In some cases, there may be multiple factors or conditions that all need to be satisfied in order to trigger learning of a new item. One factor may be a user indicating one of a particular set of information types (e.g., definition or interpretation of a term, or an output preference), and another factor may be a set of events that indicates confidence or user preference with a sufficiently high magnitude.

In the example of FIG. 1B, the learning module 142 determines that a sequence of events has occurred that provides high confidence in a particular preference for chatbot answers. In the user prompt 170b, the user asked “tell me more,” which indicates that the user desired an answer with more information. This preference, e.g., for detailed information, is a type of information that the learning criteria 141 indicates is a type that can be saved. Then, when the user indicates approval of the response 180b through interaction with the user feedback controls 183b, the learning module 142 determines that this is a confirmation that the content or format of the response 180b satisfies the user's preference. As a result, the learning module 142 determines that this feedback indicates a sufficiently high confidence in the expressed user preference (e.g., for detailed information, indicated by the request to provide more information) to save the information as a new learned item.

In response, the computer system 110 stores a new learned item 145 in the database 143 of learned items. The new learned item 145 indicates that for the user 105, User 1, the analysis level preference is detailed (e.g., rather than a normal or default level). The learned item 145 is stored in association with an identifier for the user 105, and with other information indicating the context in which the item 145 was learned. The learned item 145 will persist after the user 105 ends the current chatbot conversation, and the learned item 145 becomes immediately available to guide responses of any of the chatbots that the computer system 110 provides access to.

The computer system 110 also informs the user 105 that the new learned item 145 has been stored. For example, the computer system 110 sends data causing a notification 185 to be displayed at the user device 105. The notification 185 is provided proximate (e.g., adjacent to or visually linked to) the user feedback, showing the feedback interaction that resulted in the learning. The notification 185 indicates that learning has occurred, and also specifies or summarizes the content of what was learned, e.g., (“I learned: You prefer detailed answers.”).

In some implementations, to facilitate learning, the computer system 110 asks the AI/ML model to classify user prompts to detect when ambiguity is present. When a question is classified as ambiguous, in the sense that there are multiple different interpretations or data objects that can be used, the computer system 110 obtains from the AI/ML model the most likely options (e.g., the top 3 interpretations or data objects). The computer system 110 can then provide multiple answers or options, each determined according to a different interpretation. As a result, the user can see an alternative responses that give examples of different ways to resolve the ambiguity. Alternative answers can be made selectable so that the user 105 can indicate which alternative answer, if any, is based on the interpretation or criteria that the user intended. The computer system 110 stores a user's selection as a learned item, for that specific user, to learn the user's preference. In the future, if an ambiguous question is detected for the user 105, but the computer system 110 has records indicating a previous preference or interpretation was learned (e.g., through a previous selection by the user), then the system 110 can use the previously-learned interpretation without showing alternative answers.

In responding to open-ended questions, the system can leverage user-level learning (e.g., personal preferences) to ensure answers to open-ended answers are tailored to the user's profile and interests. For example, if a user has previously stated to include week-level revenue numbers when querying about sales performance, and now the open-ended query is: “Tell me about sales performance in the Atlanta store?” the computer system 110 should store and provide to the AI/ML model the user's preference for weekly analysis, so the results surface relevant results.

The learning capabilities of the system allow it to learn from interaction with users and for chatbot responses to get better over time, while delivering a personalized user experience. The learning can improve engagement and user satisfaction, as well as reduce frustration and reduce chat abandonment. It allows users to train chatbots through natural interactions with minimal effort.

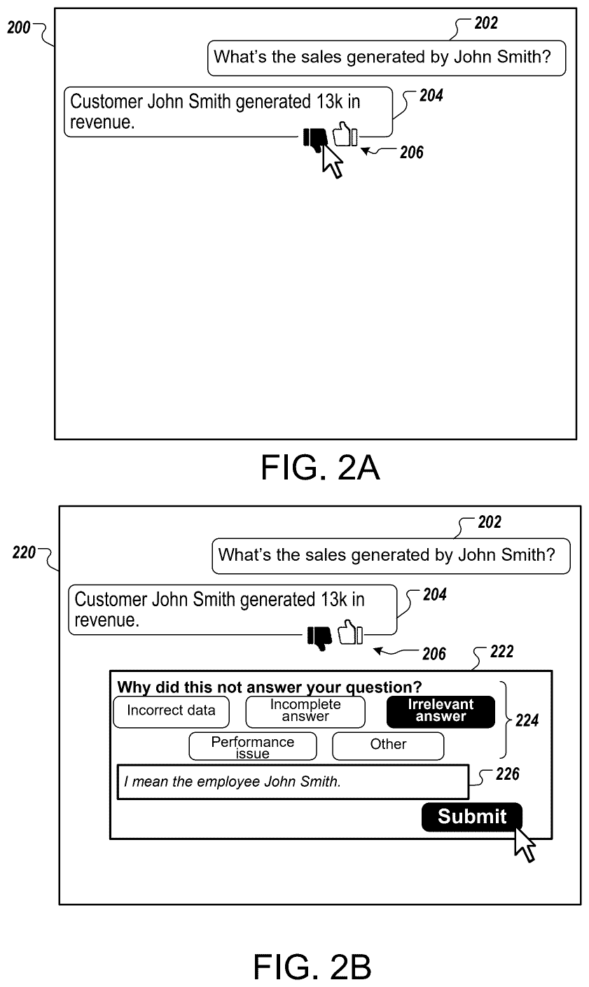

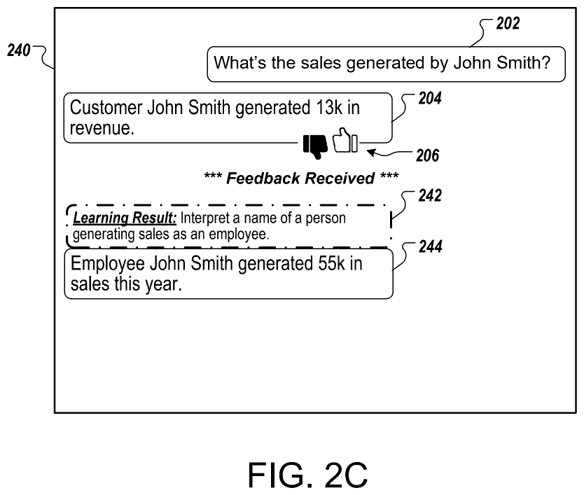

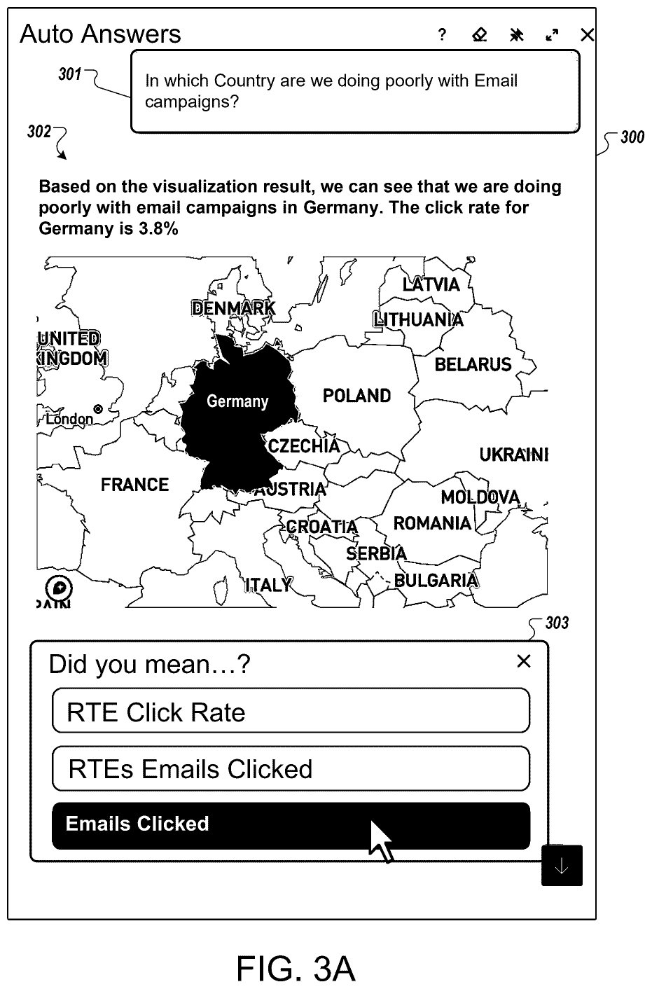

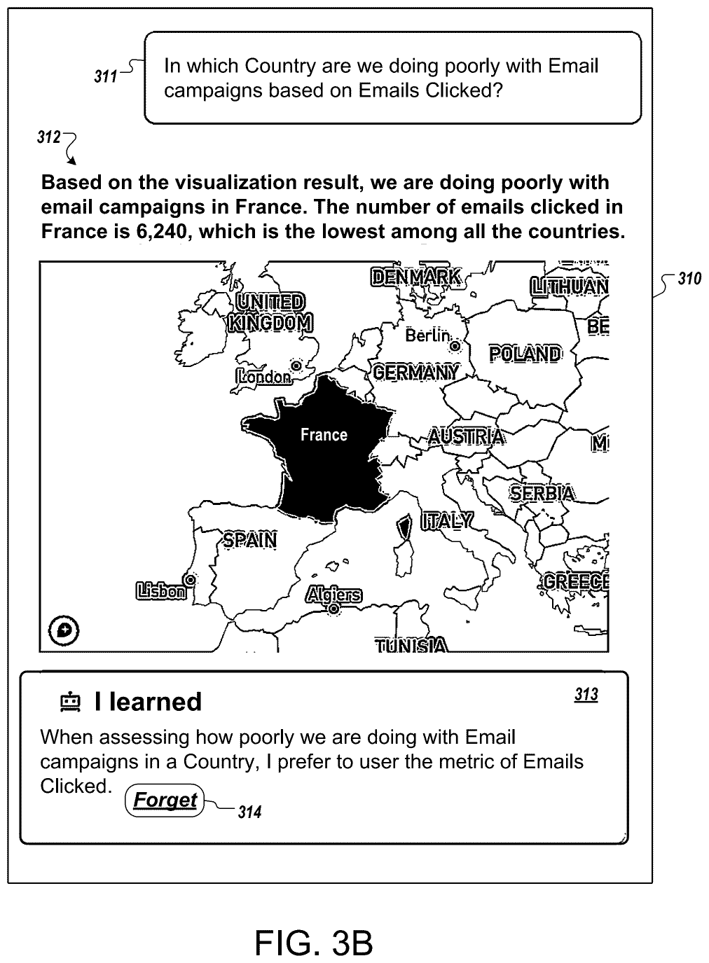

There are many scenarios in which learning can be triggered. As an example, one situation is when ambiguity is detected in the user's question, and the user chooses from one of the provided options (e.g., responding to a “Did you mean . . . ” question back to the user that provides multiple options or interpretations, see FIG. 3A). When the user selects one of the options, the system will retain the selection as a learned item for resolving the ambiguity going forward. Another example that triggers learning is a user providing negative feedback about a chatbot response (e.g., a thumbs down, or a subsequent user prompt indicating the response was incorrect or otherwise unsatisfactory) accompanied by a user comment stating the reason for user's disapproval. The user can indicate the reason by clicking one of various pre-filled feedback options (e.g., incorrect answer, incorrect format, etc., see FIG. 2B), or the user can submit a text comment in a feedback control or even as a subsequent prompt in the chatbot conversation. The negative feedback, coupled with the reason for the negative feedback, provides the system an indication of what can be learned, e.g., a mistake to be avoided or an interpretation to be corrected.

A number of example use cases are provided below.

Example 1: The user enters: “Show me accounts that have been vetted and have Open Opp N4Q S4”. The chatbot answers: “Accounts that have been Vetted Completed and have Open Opp N4Q S4 is Darden Corporation.” The user clicks the “Thumbs Down” button to disapprove of the answer, and the user provides the comment: “Accounts that have been Vetted Completed or In-Progress and have Open Opp N4Q S4.” From this, the system detects that the issue with the prior response was that it did not include results with the in-progress status. The chatbot answers: “Thanks for the feedback. Learning that Vetted Accounts includes both status (Completed and In-Progress).” The computer system 110 then stores the learned item, “Vetted Accounts includes both status (Completed and In-Progress)” as a learned item for this user in the context of this document or dashboard. The next time the user asks a question involving “Vetted Accounts,” the learned item “Vetted Accounts includes both status (Completed and In-Progress)” will be used in answering that question.

Example 2: The user asks “what is my current revenue?” The chatbot replies: “Current Revenue is 5 million dollars.” The chatbot does not apply any time filters in sourcing the data or in making the response. The user clicks the “Thumbs Down” button for the answer and the user provides the comment: “Current Revenue for January 2024. The chatbot replies: “Thanks for the feedback. Learning Current Month is Last Complete Month. As a result, the server records the learned item “Current Month is Last Complete Month,” which will be recorded for this user and for the particular document or dashboard being discussed in the conversation. The next time the user asks another question of the type “what is my Current Revenue for . . . “, the server will find and apply the stored learned item “Current Month is Last Complete Month” and the server will apply that information in formulating data retrieval (e.g., from the data sets 122a-122n) and when generating a response or summary of the data.

Example 3: The user asks, “What is the average sales for the last quarter?” The chatbot replies: “Current Average Sales for Last Quarter is Y dollars.” The user clicks the “Thumbs Down” button for the answer and provides the comment or new prompt: “Average Store level Weekly Sales for Last Quarter.” The chatbot generates a response to this subsequent query, and the user clicks the “Thumbs Up” button to indicate approval. In response to this sequence of user inputs, including the disapproval feedback followed by the approval feedback, the computer system 110 (potentially with one or more interactions with the AI/ML model 132) determines that “average sales” was intended to mean something different, e.g., the average store level weekly sales. The chatbot replies to the user's positive feedback, “Thanks for the feedback: Learning to prioritize Store level Weekly Average by Default.” The computer system 110 stores the learned item “prioritize Store level Weekly Average by Default.” for this user and this document or dashboard.

Example 4: The user enters: “Show me Top performing AEs in Q2.” The chatbot answers: “Top AE based on S6-Closed Revenue in Q2 2024 is ‘Alpha Dog.’” The user clicks the “Thumbs Down” button for the answer and provides the comment: “Top AEs based on Pipe/Market when S3-S5 License Pipe N4Q is >$200K and S6 Closed Revenue in the Quarter is >$100K.” The chatbot responds, “Thanks for the feedback. Learning that Top Account Executives are by default measured on Pipe/Market when S3-S5 License Pipe N4Q >200K and S6 Closed Revenue for Quarter is >$100K.” As a result, the learned item, “Top Account Executives are by default measured on Pipe/Market when S3-S5 License Pipe N4Q >200K and S6 Closed Revenue for Quarter is >$100K” is stored in association with this user and this document or dashboard. Next time, for any question involving “Top Account Executives” from this user, the learned item “Top Account Executives are by default measured on Pipe/Market when S3-S5 License Pipe N4Q >200K and S6 Closed Revenue for Quarter is >$100K” will be used in answering that question.

In some implementations, the computer system can provide an application-level setting to enable or disable adaptive learning. When adaptive learning is ON, the computer system 110 registers (e.g., detects and saves) new learned items based on user feedback, and applies learned items in conversations. When adaptive learning is OFF, the computer system 110 will not register new learned items, and also will not apply learned items in conversations. Apart from user-level learned items, if there are administrator-uploaded knowledge assets (e.g., knowledge base content), however, those items should continue to be used even though the status of adaptive learning is off.

The computer system 110 can apply any of a variety of triggers or types of criteria to initiate learning. One trigger is ambiguity resolution. When ambiguity is detected, the computer system 110 provides a default answer accompanied by 3 “Did you mean” options (e.g., alternative interpretations that may be used). If the user clicks on one of those options, learning should be triggered. When a learned item is generated, the computer system 110 causes it to be surfaced (e.g., displayed) on the chatbot interface and causes a user-selectable option for the user to undo or forget that learning.

Another trigger for learning can be based on user disapproval or negative feedback about a chatbot response (e.g., a “thumbs down” selection). Learning should occur when a user reacts negatively and also indicates the reason for disapproval, e.g., (1) the user writes an additional comment describing the problem with the answer or a correction to be made and/or (2) chooses one of the available tags (see FIG. 2B, e.g., ‘Incorrect data’, ‘incomplete answer’, ‘irrelevant answer’) even without additional comment. If the user chooses an answer that does not describe a correctable error (e.g., indicate a problem of ‘Response Speed’ or ‘Other’ without an additional comment), this does not trigger learning, and will only be stored for administrator review purposes.

Another trigger for learning can be clarification interactions. When the chatbot seeks clarification and the user provides specific information, such as an employee ID, the chatbot learns and remembers these details for future interactions. As an example, the user enters: “Show me my total steps.” The chatbot replies, “What is your employee ID?” The user responds, “18111.” The chatbot then replies, “Your total steps is 15,858.” In this case, the chatbot needed the employee identifier to be able to answer the question. Once that information is provided, the computer system 110 registers a new learned item, and outputs in the chatbot interface, “Learning your employee ID is 18111.” If the user likes the answer, or in some cases at least does not disapprove of the answer, a new learning is registered.

A variety of different types of information can be learned by the computer system 110. When one of the learning triggers are met, the system can send the last n messages (e.g., n=5 or another integer), the interpretations of those messages, answers and user feedback together as input to an AI/ML model 132 to assess what can be learned. The resulting string (e.g., response from the AI/ML model 132) should include the learning (e.g., a text description of the item being learned) and the context in which it was learned. The context is important, because a learned item may not always be applicable in all situations, and may need to be limited to the same or similar context (e.g., in terms of the data set, chatbot, document or dashboard, etc.). In this manner the computer system 110 can leverage the ability of an AI/ML model 132 (e.g., LLM) to understand significant amounts of contextual data to analyze portions of a conversation, with the user feedback, to extract the differences between what the chatbot provided and what the user intended. The AI/ML model 132 can be instructed to provide a concise statement of the preference or correction needed. In other words, based on analysis of the conversation and feedback (and a data model or data schema and other data also), the AI/ML model 132 can generate the learned item to be saved. For example, the AI/ML model 132 can generate the phrase or sentence that captures, e.g., the correction or preference of the user, or interpretation of a term, which can be at least in part extracted or generated from portions of the conversation.

As an example, a user may enter the question: “Which customers had a high customer satisfaction score?” The chatbot answers, “Aliya, Abigail and Adan with 3.8, 4.1 and 2.7.” The system, recognizing the potential ambiguity in what “high” should mean in terms of a customer satisfaction score, also provides potential interpretations, e.g., “Did you mean: (1) high customer satisfaction score of over 3.5, (2) high customer satisfaction score of over 4.0, or (3) high customer satisfaction score of over 4.5?” The user chooses option (3), and so the learning result is: “High customer satisfaction is defined by scores over the threshold of 4.5/5.” If the document or dashboard has another metric named performance score, and so there may be a conflict in terminology or a new ambiguity, it may or may not by default mean high performance score is >4.5/5. The system can leverage the assessment of an AI/ML model 132 (e.g., a LLM) initially and assess how it suggests learning should occur in that scenario. In many cases the model 132 may recognize the potential conflict in terms and phrase the learned information in a way that avoids the conflict.

There are many different types of items that the computer system 110 can learn. Examples include learning the meaning of specific terms, learning visualization preferences, and learning data exploration depth.

Specific Terms: The system can learn the user's intended meaning for terms such as “current,” “last period,” or “last term,” refining its understanding of time-related queries based on user feedback.

For example, the user asks “what is my Current Revenue” and the chatbot replies: “Current Revenue is 10 million dollars.” and does not apply any time filters. When the user indicates disapproval and provides the comment: “Current Revenue for January 2024,” the chatbot replies: “Thanks for the feedback. “Learning Current Month is Last Complete Month for Revenue.” In this case, the data object Revenue is the context in which this is learned.

Visualization preference: The system can learn the types of visualizations a user prefers or dislikes, tailoring the presentation of data to match the user's preferences.

For example, a user may enter, “Show me each category's revenue contribution towards the total.” The chatbot responds with correct revenue values with a pie chart visualization, which is an appropriate representation of the answer. The user clicks thumbs down and sends feedback “Not interested in pie charts. Show me a grid instead.” From this, the system can learn and store the item “Preference for grid visualization for contribution to total questions.”

Data Exploration Depth: the system can learn if the user tends to explore data superficially or deeply. For example, the user enters a question, “Tell me about revenue in New York last year.” The chatbot responds, “Revenue in New York in 2023 was USD 5.5 million.” The user either (1) follows up and asks “Tell me more,” gets a detailed answer and likes the answer, or (2) presses thumbs down and gives feedback saying “I want more insights and not just a single line answer.” Both (1) and (2) can satisfy the criteria to register a new learned item of, for example, “Prefers detailed analytical insights over brief summaries for revenue queries.”

There are some situations in which the learning module 142 (e.g., learning manager) will not register a new learned item, even if criteria for triggering learning have been satisfied. For example, if a user expresses disapproval but chooses “Performance issues” as the reason, there is no substantive item for the system to learn. Similarly, if the AI/ML model 132 is asked to generate a learned item but cannot, e.g., the LLM returns no learning based on analysis of the conversation and user feedback, then the learning process can be cancelled and no item is saved.

When learning takes place, the system can perform a number of actions. For example, the system can cause display of a message indicating what has been learned. For example, one case might be “Learned that top activities are measured by total distance covered”. The system allows users to cause the computer system 110 to undo or forget the learned item right from the chat interface, e.g., with an interactive control on the chat user interface. In response to the user indicating to forget or undo the learning, the computer system 110 deletes the specific information of that learned item from the personal learned item collection for the user.

Learned items can be surfaced in the chat interface as a bubble-type notification, and the notification may be persisted for the duration of the session only. If a user exits and re-enters the chatbot interface, e.g., resuming the conversation but in a different session, the learning bubble notifications generally should not appear, even when the rest of the chat history is loaded and shown in the chat user interface.

Each new learned item (e.g., learned piece of knowledge) can be stored as a personal ‘learned item’ in an AI search system, along with (1) a timestamp of the time it was learned or created and (2) an identifier and name for the application or object (e.g., chatbot and/or document/dashboard) the learning resulted from, which builds a repository of user-specific learned items. Each user does not need a distinct storage location, since the user identifiers allow learnings to be filtered by user for searching.

Learning is generally performed at the user level, across the library, and learned items should generally be applied at the same level. Typically, learning is not siloed per chatbot and per dashboard. Rather, learning can be shared, which is particularly relevant where the same data sets, topics, and data objects are shared across multiple chatbots or dashboards.

In some implementations, the system provides an individual learning manager, which can be a user interface (e.g., accessible in a user preferences section) to view and manage their personal leanings, allowing a user to delete or correct the system's learned items. Each row in the interface can represent a learned item.

Personal learned items can be stored using a vector embedding for each learned item in a vector database or other system that facilitates similarity search. For new questions asked by the user, the computer system 110 can deduce whether a past learned item can be applied to answer the question better, by running a relevance or nearest neighbor search using the vector database.

The computer system 110 can apply a learning precedence hierarchy. When integrating learned items and other knowledge into responses provided by chatbots, user-level learned items or learned items take precedence over application-level settings or knowledge assets uploaded by admins. In other words, if the user learning conflicts with default settings of a chatbot or application-level settings, the user learning can control and can override the other settings. This can include overriding some or all organization-level learning (e.g., a company-wide or department-wide knowledge base).

The computer system 110 can be configured to provide citations to the appropriate personal learned item in the interpretation window of the chatbot interface if an answer is influenced by a learned item. For example, the use of previous learning can be indicated, and the learned item (e.g., the text representing the learned item) itself can be provided for display, either directly in the interface or accessible by user interaction with an icon, button, or other control.

FIGS. 2A-2C are user interfaces that provide examples of learning and using learned information in conversations with an AI/ML chatbot. In FIG. 2A, the user interface 200 shows that a user has entered a prompt 202, “What's the sales generated by John Smith?” The chatbot responds with the answer 204, “Customer John Smith generated 13k in revenue.” The user interface 200 includes a set of user feedback controls 206, and the user selects a thumb-down control to indicate disapproval of the response.

In FIG. 2B, the user interface 220 shows that the computer system 110 has responded to the negative user feedback with expanded user feedback controls 222, which enable the user to provide more detailed feedback about the reason for disapproval. For example, the controls 222 include a series of categories that the user can select to indicate the reason the answer 204 was not appropriate. These category options include incorrect data, incomplete answer, irrelevant answer, a performance issue, or other. The controls 222 also include a text entry field 226, in which the user can further explain the problem with the answer 204. In the example, the user enters, “I mean the employee John Smith,” and then submits the more detailed feedback.

In FIG. 2C, the user interface 240 shows that the computer system 110 received the more detailed feedback. The computer system 110 has also taken the text feedback comment (that the user meant to interpret the name “John Smith” as an employee not a customer) along with the content of the original prompt 202 to identify a specific learned item to be saved. The computer system 110 has caused a notification 242 to be provided, which indicates what has been learned, e.g., “Learning Result: Interpret a name of a person generating sales as an employee.” Based on this new interpretation, the computer system 110 also automatically provides a new response 244 to the original prompt 202 that makes the desired interpretation, without requiring the user to ask again. The new response 244 states, “Employee John Smith generated 55k in sales this year.”

To interpret user feedback the computer system 110 has various tools for processing the information. In many cases, interpretations of text result in a mapping to a data object in a data model, and often the error to be corrected (or item to be learned) is a mapping to a data object. In the example of FIGS. 2A-2C, the error was in mapping a name to a customer data object, when the user intended the name to be mapped to an employee data object. In a data set or data model where these two data objects exist, the switch in interpretation can be detected and corrected by changing the data object mapping. The appropriate outcome is not to automatically map every name to the employee data object however. The computer system 110 uses the context information from the original prompt 202, e.g., the concept of “sales generated,” and ties the interpretation to this context. As a result, the learned item specifies to map a name to an employee data object in the context of generating sales.

The computer system 110 can facilitate learning by including templates or workflows for specific types of learning. For example, a pattern such as the types of interactions in FIGS. 2A-2C can be stored, with an indication that the correction of an interpretation, as a different data object mapping, is the type of item to be learned, if the meaning of the data object types can be resolved. To assist in this, the computer system 110 may make one or more requests to the AI/ML model 132 to perform the semantic processing or analysis of the appropriate data model to determine or verify what the appropriate new interpretation or data object mapping is.

FIGS. 3A-3B are user interfaces showing an example of learning based on a user selection to resolve an ambiguity.

FIG. 3A shows another user interface 300. The user submitted a question 301, and a default answer 302 is provided. Because the question 301 was classified as ambiguous, this system also generates and provides alternative options for interpreting the concept of performance inherent in the question 301. In this case, the options 303 specify different metrics that can be used as criteria to specify how performance should be judged.

FIG. 3B shows an example where, after the interactions of FIG. 3A, the user submits a later question 311 that refers to the same concept of performance in the same context of countries and emails being clicked. At this time, because the system has previously learned the user's preference from a selection among the options 303, the system provides an answer 312 and does not provide alternatives. Instead, the system provides a notice 313 about the criteria used, and gives the user an opportunity to forget the learned information if it is incorrect, by interacting with a learning removal control 314.

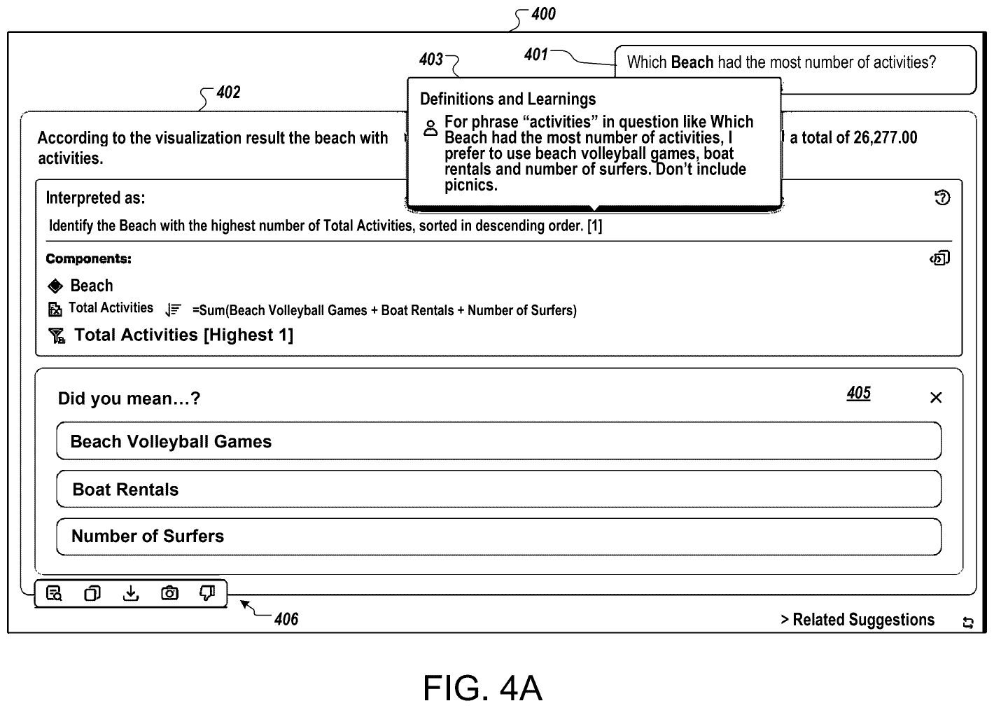

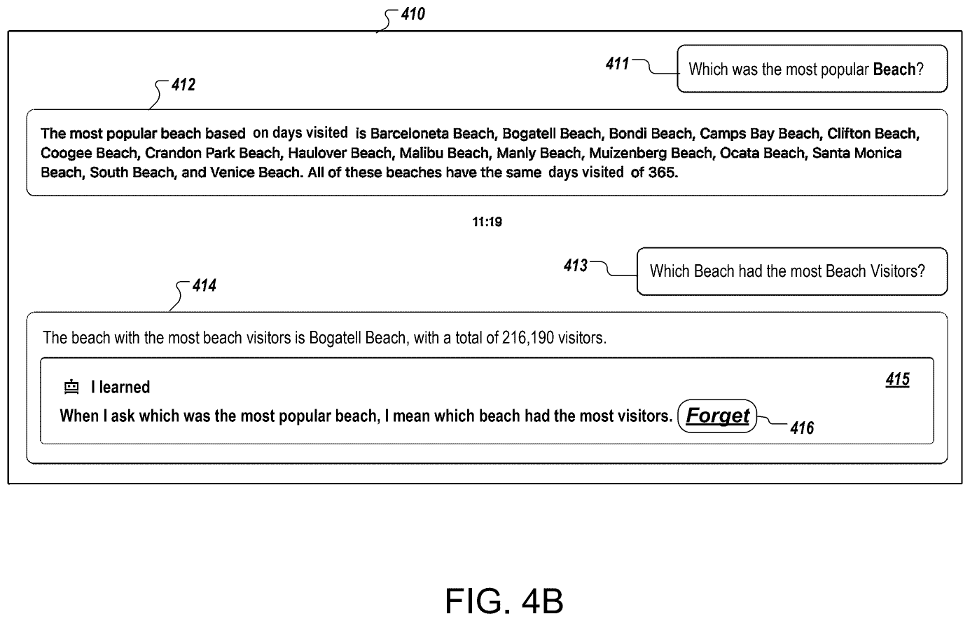

FIGS. 4A-4B are user interfaces that show learning during conversations with an AI/ML chatbot. In FIG. 4A, the user interface 400 shows that a user entered a prompt 401, “Which Beach has the most number of activities?” The computer system 110 provided a response 402 that provides a response based on a likely interpretation of the term “activities.” The response 402 includes information describing the interpretation of the users question 401 including specifying which data objects or formulas were used to arrive at the answer. The user interface 400 shows information about previous learning for the user, indicting in notification 403 that “For phrase ‘activities” in questions like Which Beach had the most number of activities, I prefer to user beach volleyball games, boat rentals, and number of surfers. Don't include picnics.” This information represent learning from one or more conversations, and may represent information built up over a series of interactions. The computer system 110 nonetheless determines that the term may still be ambiguous, and that even with the current definition there are multiple components or data types that the user might intend more specifically. As a result, the computer system 110 causes an area 405 to be displayed, which shows multiple alternative options that may more precisely represent what the user intended. These interpretation options include beach volleyball games, boat rentals, and number of surfers. The user interface also includes controls 406 to receive user feedback or to perform other actions such as copying, taking a snapshot, downloading, exporting, etc.

in FIG. 4B, a user interface 410 shows a different conversation with the chatbot. In this example, the user provides a prompt 411, “Which was the most popular Beach?” The computer system 110 provides a chatbot response that judges popularity by the number of days visited in a year, e.g., the number of days visited. The user does not interact with explicit feedback controls, but does submit a follow-up prompt 413 that asks, “Which Beach had the most Beach Visitors?” The computer system 110 provides a response 414 that indicates the beach with the most visitors. In addition, based on the second prompt 413 giving an incrementally more specific request, the computer system 110 infers that the metric the user specified later (e.g., most beach visitors) was likely the intended criterion for the broader earlier question (e.g., most popular). As a result, the computer system 110 generates a new learned item to specify this criterion, and causes a notification 415 of this learning to be provided for display. The user interface 410 includes a learning removal control 416 so the user can reject or delete the learned item if it is not correct.

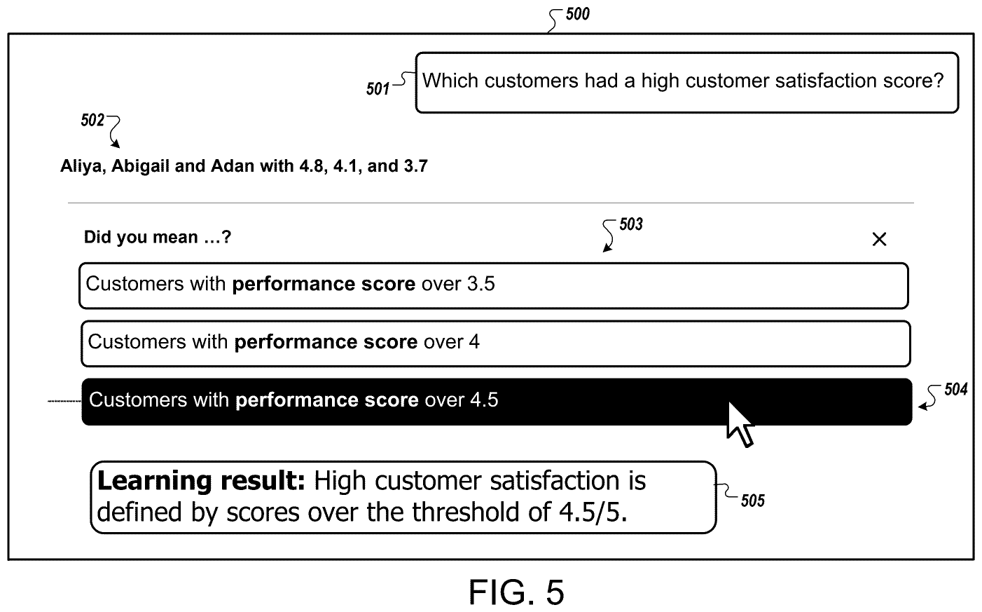

FIG. 5 is a user interface showing an example of learning during a conversation with an AI/ML chatbot. The example shows a user interface 500, showing a user prompt 501, “Which customers had a high customer satisfaction score?” Because the computer system 110 detects multiple possible interpretations for the meaning of a “high” score, the computer system 110 provides a response 502 that is accompanied by selectable options 503 that use different thresholds or criteria for determining what level would be considered to be “high.” The user selected a particular option 504, indicating that a performance score of over 4.5 should be considered high. Based on the user selection, the computer system 110 saves the information as a new learned item, and also provides the user a notification 505 of this new criteria that will be saved and used in the future.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
storing, by the one or more computers, data indicating one or more criteria for initiating learning in a chatbot system, wherein the one or more criteria indicate conditions that trigger storage of a learned item to persist across sessions or conversations;
receiving, by the one or more computers, a user prompt from a user device over a communication network;
generating, by the one or more computers, a chatbot response to the prompt using output of an artificial intelligence or machine learning (AI/ML) model;
providing, by the one or more computers, the chatbot response over the communication network as a response to the user prompt;
detecting, by the one or more computers, that the one or more criteria are satisfied; and
in response to detecting that the one or more criteria are satisfied, adding, by the one or more computers, a learned item to data storage, wherein the one or more computers are configured to use the learned item to generate chatbot responses in other sessions or conversations.

2. The method of claim 1, comprising, after providing the chatbot response, receiving data indicating user feedback for the chatbot response that is provided through user interaction with one or more user feedback controls presented in association with the chatbot response;
wherein detecting that the one or more criteria are satisfied is based on the user feedback.

3. The method of claim 2, wherein the user feedback comprises positive feedback from the user in response to the chatbot response;
wherein the method includes identifying an interpretation, a relationship, or a user preference corresponding to the chatbot response or an earlier chatbot response in the conversation; and
wherein adding the learned item comprises adding the identified interpretation, relationship, or user preference to be used to generate chatbot responses for the user in other sessions or conversations.

4. The method of claim 2, wherein the user feedback comprises negative feedback from the user in response to the chatbot response;
wherein the method includes identifying an interpretation, a relationship, or a user preference corresponding to the chatbot response or an earlier chatbot response in the conversation; and
wherein adding the learned item comprises adding an alternative interpretation, relationship, or user preference, which is different from the identified interpretation, relationship, or user preference, to be used to generate chatbot responses for the user in other sessions or conversations.

5. The method of claim 1, wherein detecting that the one or more criteria are satisfied comprises determining that user input submitted after the user prompt resolves an ambiguity in the user prompt that is identified by the system.

6. The method of claim 1, further comprising:
after receiving the user prompt, detecting an ambiguity corresponding to at least a portion of the user prompt;
providing, for display by the user device, multiple different options for resolving the ambiguity; and
receiving data indicating a user-selected option from among the multiple different options;
wherein the learned item is based on the user-selected option.

7. The method of claim 6, wherein the learned item specifies at least one of a threshold, an interpretation of a term, or a user-selected criterion.

8. The method of claim 1, wherein detecting that the one or more criteria are satisfied comprises, after providing the chatbot response to the user prompt, determining that a subsequent user prompt provides a correction to the chatbot response, requests a change to the chatbot response, or requests a different chatbot response to the user prompt.

9. The method of claim 1, wherein detecting that the one or more criteria are satisfied comprises determining that a predetermined sequence of interactions has occurred with the chatbot.

10. The method of claim 1, wherein detecting that the one or more criteria are satisfied comprises identifying, based on one or more user interactions, a piece of information of a predetermined set of types of information.

11. The method of claim 1, comprising causing one or more user feedback controls to be presented in association with the chatbot response, wherein the one or more user feedback controls indicate at least one control to indicate approval or disapproval of a chatbot response;
wherein adding the learned item to the data storage is based on user interaction with the one or more feedback controls.

12. The method of claim 1, comprising providing, for display by the user device, a notification that (i) describes the learned item and (ii) indicates that the learned item has been saved.

13. The method of claim 1, wherein adding the earned item to the data storage comprises associating the learned item with an identifier for a particular user, wherein the one or more computers are configured to use the learned item to generate chatbot responses in other sessions or conversations of the particular user.

14. The method of claim 13, wherein the one or more computers are configured to use the learned item selectively based on whether the one or more computers determine that the learned item is relevant to a user prompt submitted by the particular user.

15. The method of claim 1, wherein the AI/ML model comprises a large language model.

16. A system comprising:
one or more computers; and
one or more computer-readable media storing instructions that are operable, when executed by the one or more computers, to cause the one or more computers, to perform operations comprising:
storing, by the one or more computers, data indicating one or more criteria for initiating learning in a chatbot system, wherein the one or more criteria indicate conditions that trigger storage of a learned item to persist across sessions or conversations;
receiving, by the one or more computers, a user prompt from a user device over a communication network;
generating, by the one or more computers, a chatbot response to the prompt using output of an artificial intelligence or machine learning (AI/ML) model;
providing, by the one or more computers, the chatbot response over the communication network as a response to the user prompt;
detecting, by the one or more computers, that the one or more criteria are satisfied; and
in response to detecting that the one or more criteria are satisfied, adding, by the one or more computers, a learned item to data storage, wherein the one or more computers are configured to use the learned item to generate chatbot responses in other sessions or conversations.

17. The system of claim 16, wherein the operations comprise, after providing the chatbot response, receiving data indicating user feedback for the chatbot response that is provided through user interaction with one or more user feedback controls presented in association with the chatbot response;
wherein detecting that the one or more criteria are satisfied is based on the user feedback.

18. The system of claim 17, wherein the user feedback comprises positive feedback from the user in response to the chatbot response;
wherein the operations comprise identifying an interpretation, a relationship, or a user preference corresponding to the chatbot response or an earlier chatbot response in the conversation; and
wherein adding the learned item comprises adding the identified interpretation, relationship, or user preference to be used to generate chatbot responses for the user in other sessions or conversations.

19. The system of claim 17, wherein the user feedback comprises negative feedback from the user in response to the chatbot response;
wherein the method includes identifying an interpretation, a relationship, or a user preference corresponding to the chatbot response or an earlier chatbot response in the conversation; and
wherein adding the learned item comprises adding an alternative interpretation, relationship, or user preference, which is different from the identified interpretation, relationship, or user preference, to be used to generate chatbot responses for the user in other sessions or conversations.

20. One or more non-transitory computer-readable media storing instructions that are operable, when executed by the one or more computers, to cause the one or more computers, to perform operations comprising:
storing, by the one or more computers, data indicating one or more criteria for initiating learning in a chatbot system, wherein the one or more criteria indicate conditions that trigger storage of a learned item to persist across sessions or conversations;
receiving, by the one or more computers, a user prompt from a user device over a communication network;
generating, by the one or more computers, a chatbot response to the prompt using output of an artificial intelligence or machine learning (AI/ML) model;
providing, by the one or more computers, the chatbot response over the communication network as a response to the user prompt;
detecting, by the one or more computers, that the one or more criteria are satisfied; and
in response to detecting that the one or more criteria are satisfied, adding, by the one or more computers, a learned item to data storage, wherein the one or more computers are configured to use the learned item to generate chatbot responses in other sessions or conversations.
